(19) United States
(12) Patent Application Publication
(10) Pub. No.: US 2025/0356791 A1
(43) Pub. Date: Nov. 20, 2025

(54) DISPLAY DEVICE

(71) Applicant: Samsung Display Co., LTD., Yongin-si (KR)

(72) Inventor: Takeshi KATO, Yongin-si (KR)

(73) Assignee: Samsung Display Co., LTD., Yongin-si (KR)

(21) Appl. No.: 19/076,365

(22) Filed: Mar. 11, 2025

(30) Foreign Application Priority Data
May 17, 2024 (KR) 10-2024-0064392

(51) Int. Cl. G09G 3/20

(52) U.S. Cl. CPC G09G 3/2092; G09G 2300/0452; G09G 2320/0242; G09G 2340/0407

(57) ABSTRACT

Provided is a display device including a display panel including first pixels disposed in a first display area and including first light emitting elements having a first resolution, and a second pixel disposed in a second display area adjacent to the first display area and including second light emitting elements having a second resolution lower the first resolution, and a controller that receives input image data including first data units corresponding to the first light emitting elements and second data units corresponding to the second light emitting elements. The second data units have the first resolution. The controller generates third data units having the second resolution by rendering the second data units. The second light emitting elements are driven based on the third data units.

### CROSS-REFERENCE TO RELATED APPLICATION(S)

This application claims priority to and benefits of Korean patent application No. 10-2024-0064392 under 35 U.S.C. § 119 filed on May 17, 2024, in the Korean Intellectual Property Office, the entire contents of which are incorporated herein by reference.

### BACKGROUND

### 1. Technical Field

The disclosure generally relates to a display device. More particularly, the disclosure relates to a display device with improved display quality.

### 2. Description of the Related Art

Recently, research and development on display devices have been ongoing as interest in information display has grown.

As the display devices are complicated, the need for excellent and improved display quality is increased.

### SUMMARY

Various embodiments of the disclosure are directed to a display device with improved display quality.

An embodiment of the disclosure may provide a display device, including: a display panel including first pixels disposed in a first display area and including first light emitting elements having a first resolution, and a second pixel disposed in a second display area around the first display area and including second light emitting elements having a second resolution lower the first resolution; and a controller that receives input image data including first data units corresponding to the first light emitting elements and second data units corresponding to the second light emitting elements. The second data units may have the first resolution. The controller may generate third data units having the second resolution by rendering the second data units. The second light emitting elements may be driven based on the third data units.

The controller may generate a first rendered data unit by mixing data units corresponding to a first color among the second data units, and to generate a second rendered data unit by mixing data units corresponding to a second color among the second data units. The first and the second rendered data units may be included in the third data units.

The controller may generate the first rendered data unit by calculating an average of the data units corresponding to the first color among the second data units, and may generate the second rendered data unit by calculating an average of the data units corresponding to the second color among the second data units.

In an embodiment, light emitting elements corresponding to the first and the second colors among the second light emitting elements may be driven based on the first and the second rendered data units.

In an embodiment, a light emitting element that emits light of a first color among the second light emitting elements may have a size greater than a size of a light emitting element that emits light of the first color among the first light emitting elements.

A number of the second light emitting elements may be less than a number of the first light emitting elements.

The second display area may be disposed adjacent to at least one of edge areas of the display panel that are positioned around the first display area.

The edge areas may include side edge areas and corner areas connecting the side edge areas to each other. The side edge areas may include: first and second side edge areas extending in a first direction; and third and fourth side edge areas extending in a second direction intersecting with the first direction, and formed longer than the first and the second side edge areas. The corner areas may include: a first corner area connecting the first side edge area and the third side edge area; a second corner area connecting the third side edge area and the second side edge area; a third corner area connecting the second side edge area and the fourth side edge area; and a fourth corner area connecting the fourth side edge area and the first side edge area. The second display area may be disposed adjacent to at least one of the first to the fourth corner areas.

An embodiment of the disclosure may provide a display device, including: a display panel including first pixels disposed in a first display area and including first light emitting elements, and a second pixel disposed in a second display area adjacent to the first display area and including second light emitting elements; and a controller that receives input image data including first data units corresponding to the first light emitting elements and second data units corresponding to the second light emitting elements. The second data units may have a first resolution corresponding to the first light emitting elements. Light emitting elements corresponding to an identical color among the second light emitting elements may be electrically connected to each other. The controller may generate third data units having a second resolution lower than the first resolution by rendering the second data units. The second light emitting elements may be driven based on the third data units.

The second light emitting elements may include: 2-1-th light emitting elements that emit light of a first color and electrically connected to each other; and 2-2-th light emitting elements that emit light of a second color and electrically connected to each other. The controller may generate a first rendered data unit by mixing data units corresponding to the first color among the second data units, and may generate a second rendered data unit by mixing data units corresponding to the second color among the second data units. The first and the second rendered data units may be included in the third data units.

The controller may generate the first rendered data unit by calculating an average of the data units corresponding to the first color among the second data units, and may generate the second rendered data unit by calculating an average of the data units corresponding to the second color among the second data units.

The 2-1-th light emitting elements may be driven together based on the first rendered data unit. The 2-2-th light emitting elements may be driven together based on the second rendered data unit.

The second light emitting elements may further include: 2-3-th light emitting elements that emit light of a third color and electrically connected to each other; and 2-4-th light emitting elements that emit light of the third color and electrically connected to each other. The controller may generate a third rendered data unit by mixing some of data units corresponding to the third color among the second data units, and may generate a fourth rendered data unit by mixing some other of the data units corresponding to the third color among the second data units. The third data units may further include the third and the fourth rendered data units.

The controller may generate the third rendered data unit by calculating an average of some of the data units corresponding to the third color among the second data units, and may generate the fourth rendered data unit by calculating an average of some other of the data units corresponding to the third color among the second data units.

The 2-3-th light emitting elements may be driven together based on the third rendered data unit. The 2-4-th light emitting elements may be driven together based on the fourth rendered data unit.

The display panel may further include first sub-pixel circuits respectively electrically connected to the first light emitting elements, and second sub-pixel circuits electrically connected to the second light emitting elements. The light emitting elements corresponding to the identical color among the second light emitting elements may be electrically connected together to any one of the second sub-pixel circuits.

A number of the second light emitting elements may be substantially equal to a number of the first light emitting elements.

### BRIEF DESCRIPTION OF THE DRAWINGS

FIG. 1 is a schematic block diagram illustrating a display device in accordance with embodiments of the disclosure.

FIG. 2 is a schematic block diagram illustrating an embodiment of a controller included in the display device of FIG. 1.

FIG. 3 is a schematic circuit diagram illustrating an embodiment of a sub-pixel included in the display device of FIG. 1.

FIG. 4 is a schematic plan view illustrating an embodiment of a display area in the display device of FIG. 1.

FIG. 5 is a schematic plan view illustrating another embodiment of the display area in the display device of FIG. 1.

FIG. 6 is a schematic cross-sectional view taken along line I-I′ of FIG. 4.

FIG. 7 is a schematic plan view illustrating an embodiment of light emitting elements included in sub-pixels of FIG. 1.

FIG. 8 is an enlarged schematic view illustrating portion A of FIG. 4, in accordance with embodiments of a display panel.

FIG. 9 is a schematic diagram illustrating an embodiment of data units used in a rendering block of FIG. 2.

FIG. 10 is a schematic diagram illustrating an example where data units rendered in the rendering block of FIG. 2 are generated.

FIG. 11 is a schematic diagram illustrating arrangement of sub-pixel circuits in accordance with an embodiment of FIG. 8.

FIGS. 12 and 13 are enlarged schematic views illustrating portion A of FIG. 4, in accordance with other embodiments of the display panel.

FIG. 14 is a schematic diagram illustrating an example where data units rendered in the rendering block of FIG. 2 are generated, in accordance with an embodiment of FIG. 13.

FIG. 15 is a schematic diagram illustrating arrangement of sub-pixel circuits in accordance with an embodiment of FIG. 13.

FIG. 16 is a schematic diagram illustrating an electronic device to which the display device in accordance with embodiments of the disclosure is applied.

### DETAILED DESCRIPTION OF THE EMBODIMENTS

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the invention. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. In case that an embodiment may be implemented differently, a specific process order may be performed differently from the described order. For example, two consecutively described processes may be performed substantially at the same time or performed in an order opposite to the described order. Also, like reference numerals and/or reference characters denote like elements.

In case that an element, such as a layer, is referred to as being “on,” “connected to,” or “coupled to” another element or layer, it may be directly on, connected to, or coupled to the other element or layer or intervening elements or layers may be present. In case that, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the X-axis, the Y-axis, and the Z-axis are not limited to three axes of a rectangular coordinate system, such as the x, y, and z axes, and may be interpreted in a broader sense. For example, the X-axis, the Y-axis, and the Z-axis may be perpendicular to one another, or may represent different directions that are not perpendicular to one another. For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” in case that used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

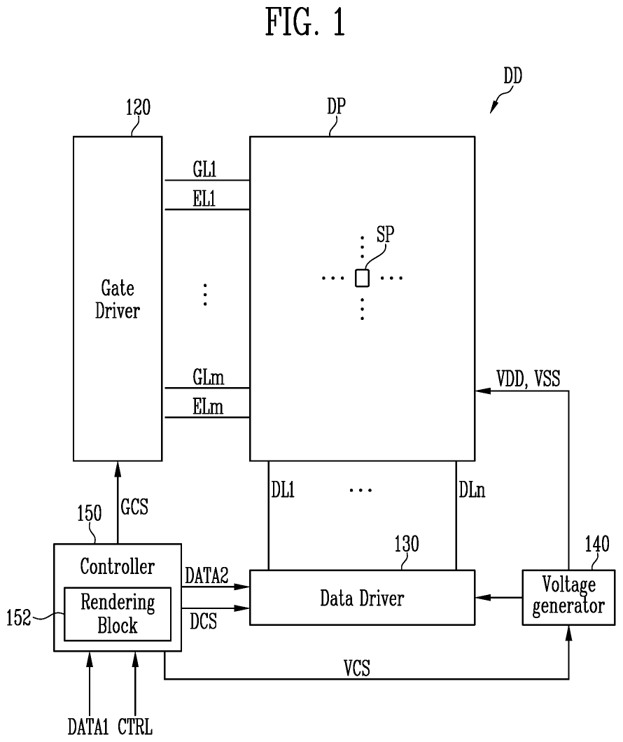

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts. FIG. 1 is a schematic block diagram illustrating a display device DD in accordance with embodiments of the disclosure.

Referring to FIG. 1, the display device DD may include a display panel DP, a gate driver 120, a data driver 130, a voltage generator 140, and a controller 150.

The display panel DP may include sub-pixels SP. The sub-pixels SP may be electrically connected to the gate driver 120 through first to m-th gate lines GL1 to GLm. The sub-pixels SP may be electrically connected to the data driver 130 through first to n-th data lines DL1 to DLn.

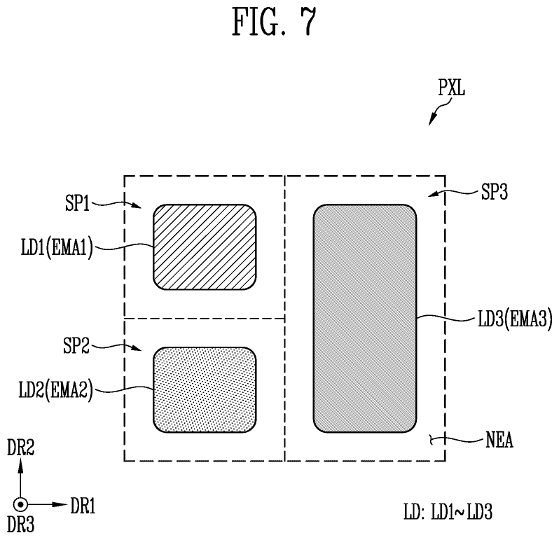

Each of the sub-pixels SP may include at least one light emitting element that generates light. Accordingly, each of the sub-pixels SP may generate light in a specific color such as red, green, blue, cyan, magenta, or yellow. For example, three or more sub-pixels among the sub-pixels SP may form one pixel. For example, as illustrated in FIG. 7, three sub-pixels may form one pixel.

The gate driver 120 may be electrically connected to sub-pixels SP arranged in a row direction through first to m-th gate lines GL1 to GLm. The gate driver 120 may output gate signals to the first to m-th gate lines GL1 to GLm in response to a gate control signal GCS. The gate control signal GCS may include a start signal instructing each frame to start, a horizontal synchronization signal for outputting gate signals in synchronization with a timing at which data signals are applied, and the like.

There may be further provided first to m-th emission control lines EL1 to ELm electrically connected to the sub-pixels SP in the row direction. For example, the gate driver 120 may include an emission control driver to control the first to m-th emission control lines EL1 to ELm. The emission control driver may operate under the control of the controller 150.

The gate driver 120 may be disposed on a side of the display panel DP. However, embodiments are not limited to the aforementioned example. For example, the gate driver 120 may be divided into two or more drivers that are physically and/or logically distinguished from each other. The drivers may be disposed on a first side of the display panel DP and a second side of the display panel DP opposite to the first side. As such, the gate driver 120 may be disposed around the display panel DP in various forms depending on the embodiments.

The data driver 130 may be electrically connected to sub-pixels SP arranged in a column direction through the first to n-th data lines DL1 to DLn. The data driver 130 may receive image data DATA2 and a data control signal DCS from the controller 150. The data driver 130 may be operated in response to the data control signal DCS. The data control signal DCS may include a source start pulse, a source shift clock, a source output enable signal, and the like.

The data driver 130 may apply, using voltages from the voltage generator 140, data signals having grayscale voltages corresponding to the image data DATA2 to the first to n-th data lines DL1 to DLn. In case that a gate signal is applied to each of the first to m-th gate lines GL1 to GLm, data signals corresponding to the image data DATA may be applied to the data lines DL1 to DLn. Hence, the associated sub-pixels SP may generate light corresponding to the data signals. As a result, an image may be displayed on the display panel DP.

The gate driver 120 and the data driver 130 may include complementary metal-oxide semiconductor (CMOS) circuit elements.

The voltage generator 140 may operate in response to a voltage control signal VCS provided from the controller 150. The voltage generator 140 may generate multiple voltages and provide the generated voltages to components of the display device DD. For example, the voltage generator 140 may be receive an input voltage from an external device provided outside the display device DD, adjust the received voltage, and regulate the adjusted voltage, thus generating multiple voltages.

The voltage generator 140 may generate a first power voltage VDD and a second power voltage VSS. The generated first and second power voltages VDD and VSS may be provided to the sub-pixels SP. The first power voltage VDD may have a relatively high voltage level. The second power voltage VSS may have a voltage level lower than the first power voltage VDD. In other embodiments, the first power voltage VDD or the second power voltage VSS may be provided by an external device of the display device DD.

The voltage generator 140 may generate various voltages. For example, the voltage generator 140 may generate an initialization voltage to be applied to the sub-pixels SP. For example, during a sensing operation for sensing electrical characteristics of transistors and/or light emitting elements of the sub-pixels SP, a certain reference voltage may be applied to each of the first to n-th data lines DL1 to DLn. The voltage generator 140 may generate the reference voltage.

The controller 150 may control overall operations of the display device DD. The controller 150 may receive input image data DATA1 and a control signal CTRL for controlling an operation of displaying the input image data DATA1 from an external device (e.g., a graphic processor). The controller 150 may provide a gate control signal GCS, a data control signal DCS, and a voltage control signal VCS, in response to the control signal CTRL. The control signal CTRL may include a vertical synchronization signal, a horizontal synchronization signal, a reference clock signal, and the like. The vertical synchronization signal may refer to a start of frame data (i.e., data corresponding to a frame period in which one frame image is displayed). The horizontal synchronization signal may refer to a start of a data row (i.e., one data row among multiple data rows included in the frame data).

The controller 150 may convert the input image data DATA1 to be suitable for the display device DD or the display panel DP to output image data DATA2. For example, the controller 150 may convert input image data DATA1 in RGB format into image data DATA2 having a format corresponding to pixel arrangement (e.g., Pentile® arrangement) in the display panel DP. For example, the controller 150 may use a rendering block 152 to convert the input image data DATA1 into the image data DATA2.

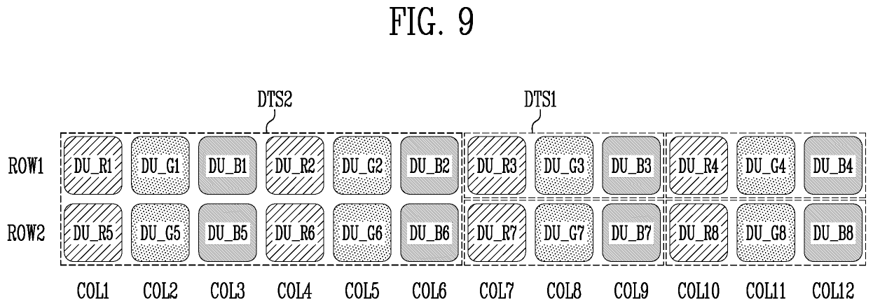

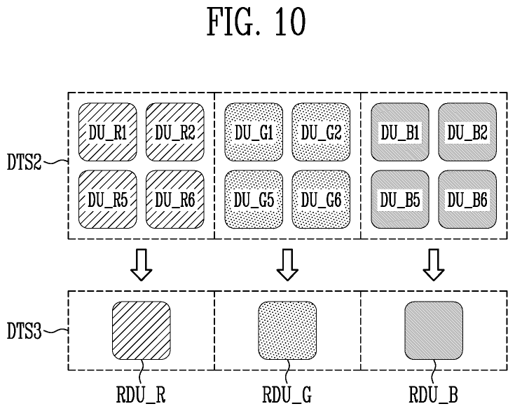

The controller 150 may apply sub-pixel rendering technology to the input image data DATA1 to generate the image data DATA2. For example, the controller 150 may reduce the resolution of input image data DATA1 corresponding to an edge (or outermost edge) area of the display panel DP and generate image data DATA2. For example, data units (or grayscale values, or grayscale levels) in the image data DATA2 for low-resolution pixels positioned in the edge area of the display panel DP may be generated by rendering corresponding data units in the input image data DATA1. The luminance of a pixel positioned in at least one edge area of the display panel DP may be adjusted according to the image data DATA2 including the rendered data units. As a result, the edge area with a relatively low resolution may be driven with an appropriate grayscale level, thereby improving the visibility of the display panel DP. Rendering and rendered data units generated by the rendering will be described later with reference to FIGS. 9 and 10.

Two or more components of the data driver 130, the voltage generator 140, and the controller 150 may be mounted on a single integrated circuit. For example, the data driver 130, the voltage generator 140, and the controller 150 may be components that are functionally separated from each other in the single integrated circuit. In other embodiments, at least one of the data driver 130, the voltage generator 140, and the controller 150 may be provided as a separate component distinct from the integrated circuit.

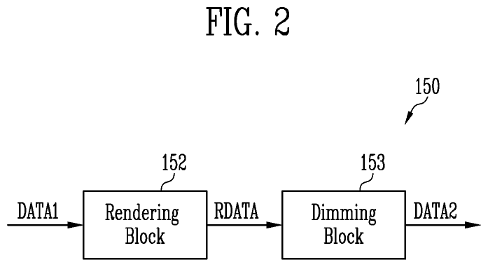

FIG. 2 is a schematic block diagram illustrating an embodiment of the controller 150 included in the display device DD of FIG. 1.

In FIG. 2, the controller 150 is schematically illustrated, focusing on a function of converting input image data DATA1 into image data DATA2.

Referring to FIGS. 1 and 2, the controller 150 may include a rendering block 152 (or a sub-pixel rendering block, or a sub-pixel rendering circuit) and a dimming block 153 (or a dimming circuit). Each of the rendering block 152 and the dimming block 153 may be implemented as hardware including a logic circuit, a memory element, and the like, or as software performing some functions in a processor (or an integrated circuit).

The rendering block 152 may generate rendering data RDATA from input image data DATA1 using a sub-pixel rendering algorithm. For example, the rendering block 152 may generate the rendering data RDATA including rendered data units by mixing the data units (or grayscale values, or grayscale levels) included in the input image data DATA1 according to colors. The rendering block 152 will be described later with reference to FIGS. 9 and 10.

The dimming block 153 may generate image data DATA2 by changing (or dimming) a data value in rendering data RDATA for sub-pixels SP positioned in at least one edge area of the display panel DP.

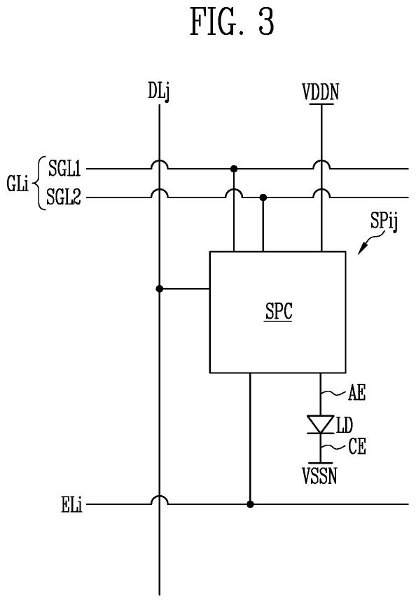

FIG. 3 is a schematic circuit diagram illustrating an embodiment of a sub-pixel SP included in the display device DD of FIG. 1.

In FIG. 3, a sub-pixel SPij is illustrated, disposed on an i-th row (where i is an integer equal to or greater than 1 and less than or equal to m) and a j-th column (where j is an integer equal to or greater than 1 and less than or equal to n) among the sub-pixels SP of FIG. 1.

Referring to FIG. 3, the sub-pixel SPij may include a sub-pixel circuit SPC and a light emitting element LD.

The light emitting element LD may be electrically connected between a first power voltage node VDDN and a second power voltage node VSSN. For example, the sub-pixel circuit SPC may be electrically connected to the light emitting element LD. The first power voltage node VDDN may be a node that transmits the first power voltage VDD of FIG. 1. The second power voltage node VSSN may be a node that transmits the second power voltage VSS.

An anode electrode AE of the light emitting element LD may be electrically connected to the first power voltage node VDDN through the sub-pixel circuit SPC. A cathode electrode CE of the light emitting element LD may be electrically connected to the second power voltage node VSSN. For example, the anode electrode AE of the light emitting element LD may be electrically connected to the first power voltage node VDDN through one or more transistors included in the sub-pixel circuit SPC.

The sub-pixel circuit SPC may be electrically connected to an i-th gate line GLi among the first to m-th gate lines GL1 to GLm of FIG. 1, an i-th emission control line ELi among the first to m-th emission control lines EL1 to ELm of FIG. 1, and a j-th data line DLj among the first to n-th data lines DL1 to DLn of FIG. 1. The sub-pixel circuit SPC may control the light emitting element LD in response to signals received through the aforementioned signal lines.

The sub-pixel circuit SPC may operate in response to a gate signal received through the i-th gate line GLi. The i-th gate line GLi may include one or more sub-gate lines. As illustrated in FIG. 2, the i-th gate line GLi may include first and second sub-gate lines SGL1 and SGL2. The sub-pixel circuit SPC may operate in response to gate signals received through the first and second sub-gate lines SGL1 and SGL2. As such, in the case where the i-th gate line GLi includes two or more sub-gate lines, the sub-pixel circuit SPC may operate in response to gate signals received through the corresponding sub-gate lines.

The sub-pixel circuit SPC may operate in response to an emission control signal received through the i-th emission control line ELi. The i-th emission control line ELi may include one or more sub-emission control lines. In the case where the i-th emission control line ELi includes two or more sub-emission control lines, the sub-pixel circuit SPC may operate in response to emission control signals received through the corresponding sub-emission control lines.

The sub-pixel circuit SPC may receive a data signal through a j-th data line DLj. The sub-pixel circuit SPC may store a voltage corresponding to the data signal in response to at least one of gate signals received through the first and second sub-gate lines SGL1 and SGL2. The sub-pixel circuit SPC may adjust current flowing from the first power voltage node VDDN to the second power voltage node VSSN through the light emitting element LD according to the stored voltage, in response to the emission control signal received through the i-th emission control line ELi. Therefore, the light emitting element LD may emit light with a luminance corresponding to the data signal.

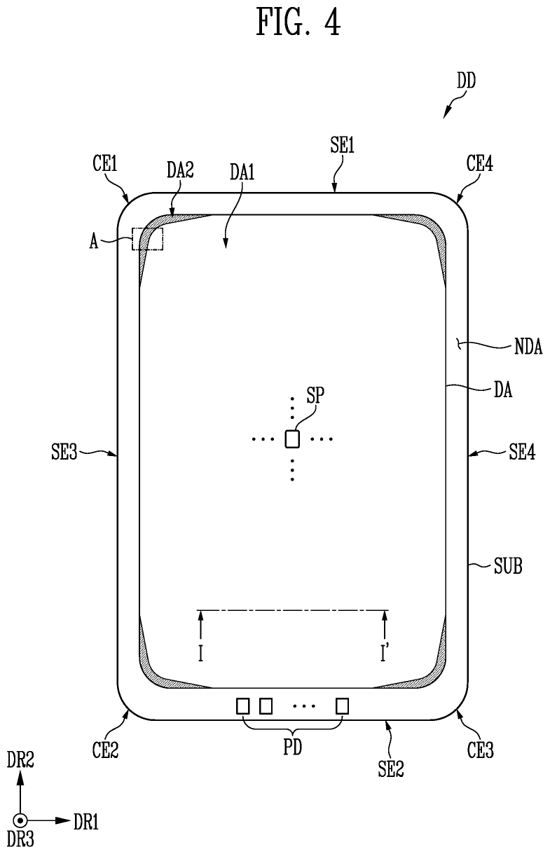

FIG. 4 is a schematic plan view illustrating an embodiment of a display area DA in the display device DD of FIG. 1.

FIG. 4 illustrates positions at which a first display area DA1, a second display area DA2, and a non-display area NDA are disposed in case that the display device DD is viewed from a third direction D3 (e.g., viewed in a plan view).

Referring to FIG. 4, the display panel DP (refer to FIG. 1) may be disposed on a front surface of the display device DD. The display panel DP may include a display area DA to display an image, and a non-display area NDA enclosing the display area DA. Pad area PD may be disposed in the non-display are NDA.

The display area DA may include a first display area DA1, and second display areas DA2 adjacent to the first display area DA1. For example, the second display area DA2 may be disposed around each corner portion of the first display area DA1. The first and second display areas DA1 and DA2 may be areas where multiple sub-pixels SP (or pixels) are disposed, and may be active areas. The first and second display areas DA1 and DA2 may be disposed as a large screen to occupy most of the front surface of the display device DD.

The non-display area NDA may be formed around the first and second display areas DA1 and DA2, and may be provided in an edge area of the front surface of the display device DD. The non-display area NDA may be a non-active area, a bezel area, or a black matrix (BM) area. The non-display area NDA may comprehensively refer to a remaining area of the display panel DP other than the first and second display areas DA1 and DA2. For example, the non-display area NDA may include driving elements, lines, various dummy areas, and the like for applying driving signals to the first and second display areas DA1 and DA2. For example, various lines electrically connected to the gate driver 120, the data driver 130, the voltage generator 140, and the controller 150 that are illustrated in FIG. 1 and to drive the sub-pixels SP in the first and second display areas DA1 and DA2 may be disposed in the non-display area NDA.

The first and second display areas DA1 and DA2 may include multiple sub-pixels SP including light emitting elements LD. The second display areas DA2 may be positioned between the first display area DA1 and the non-display area NDA. The first and second display areas DA1 and DA2 may have different resolutions. For example, the size of each of the light emitting elements included in the pixels disposed in the second display areas DA2 may be greater than the size of each of the light emitting elements included in the pixels disposed in the first display area DA1. The second display areas DA2 may have larger emission areas per unit pixel compared to the first display area DA1. Therefore, the resolution of the pixels disposed in the second display areas DA2 may be lower than that of the pixels disposed in the first display area DA1. For example, the pixels disposed in the second display areas DA2 may have light emitting elements corresponding to a relatively low resolution.

Each of the second display areas DA2 may be disposed adjacent to at least one of the edge areas of the display panel DP that are positioned around the first display area DA1. The edge areas of the display panel DP may include side edge areas, and corner areas connecting the side edge areas to each other.

Each of the second display areas DA2 may be disposed adjacent to any one of first to fourth corner areas CE1 to CE4. Each of the second display areas DA2 may be an area disposed in a curved shape along any one of the first to fourth corner areas CE1 to CE4. For example, one of the second display areas DA2 may be disposed adjacent to the first corner area CE1. One of the second display areas DA2 may be disposed adjacent to the second corner area CE2. One of the second display areas DA2 may be disposed adjacent to the third corner area CE3. Furthermore, one of the second display areas DA2 may be disposed adjacent to the fourth corner area CE4. The second display areas DA2 may be spaced apart from each other, and may be respectively adjacent to the first to fourth corner areas CE1 to CE4. As such, the second display areas DA2 may be areas that are adjacent to the corner areas of the edge areas of the display panel DP and are disposed adjacent to the first display area DA1.

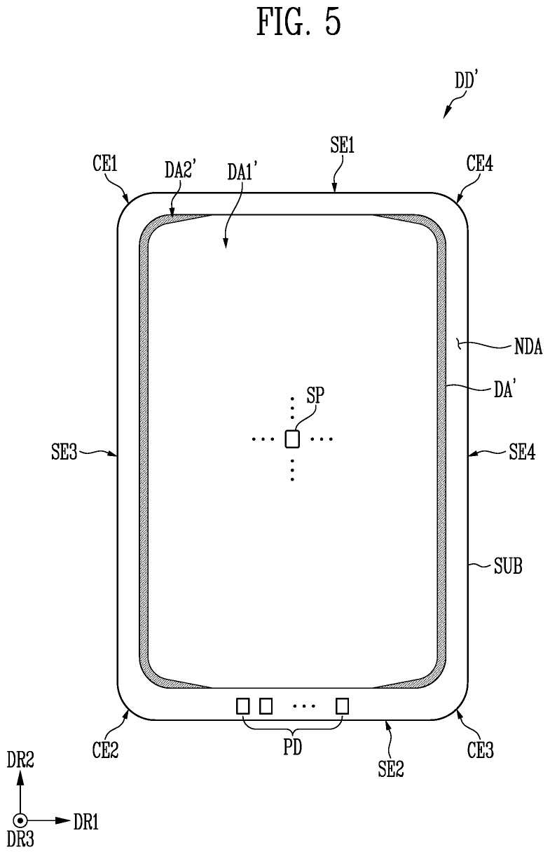

FIG. 5 is a schematic plan view illustrating another embodiment of the display area in the display device of FIG. 1.

Referring to FIG. 5, the display area DA′ may include a first display area DA1′ and second display areas DA2′ adjacent to the first display area DA1′. The second display areas DA2′ of a display device DD′ may be adjacent to at least one of corner areas and side edge areas of the display panel DP that are positioned around a first display area DA1′. Hereinafter, descriptions that are redundant with those explained with reference to FIG. 4 will be omitted.

Each of the second display areas DA2′ may be disposed adjacent to any one of first to fourth corner areas CE1 to CE4. Each of the second display areas DA2′ may be disposed adjacent to any one of first to fourth side edge areas SE1 to SE4. The side edge areas SE1 to SE4 may include the first to fourth side edge areas SE1 to SE4. The first and second side edge areas SE1 and SE2 may extend in the first direction DR1. The third and fourth side edge areas SE3 and SE4 may extend in a second direction DR2 intersecting the first direction DR1, and may be longer than the first and second side edge areas SE1 and SE2.

For example, one of the second display areas DA2′ may be disposed adjacent to the first and second corner areas CE1 and CE2 and the third side edge area SE3 disposed between the first and second corner areas CE1 and CE2 and extending in the second direction DR2. One of the second display areas DA2′ may be disposed adjacent to the third and fourth corner areas CE3 and CE4 and the fourth side edge area SE4 disposed between the third and fourth corner areas CE3 and CE4 and extending in the second direction DR2. The third and fourth side edge areas SE3 and SE4 may correspond to side portions of the display panel DP. As such, the second display areas DA2′ may be disposed adjacent both to the corner areas of the display panel DP and to some of the side edge areas disposed between the corner areas.

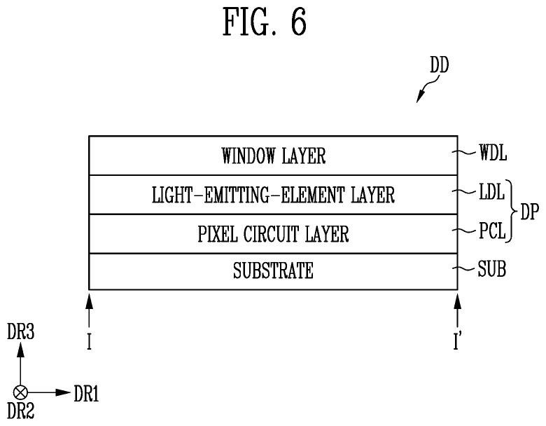

FIG. 6 is a schematic cross-sectional view taken along line I-I′ of FIG. 4.

Referring to FIG. 6, the display device DD may include a substrate SUB, a display panel DP, and a window layer WDL. The display panel DP may include a pixel circuit layer PCL and a light-emitting-element layer LDL.

The substrate SUB may include a semiconductor substrate. For example, the substrate SUB may include a silicon bulk wafer, or an epitaxial wafer. The epitaxial wafer may include a crystalline material layer, i.e., an epitaxial layer, grown on a bulk substrate through an epitaxial process. The substrate SUB is not limited to the bulk wafer or the epitaxial wafer, but may be formed using various wafers such as a polished wafer, an annealed wafer, and silicon on insulator (SOI) wafer.

The pixel circuit layer PCL may be disposed on the substrate SUB. The pixel circuit layer PCL may include circuit elements of the sub-pixel circuit SPC (refer to FIG. 2), and at least one insulating layer positioned between the circuit elements. The circuit elements may include multiple transistors, and signal lines electrically connected to the transistors. For example, the transistors may be metal oxide semiconductor field effect transistors (MOSFETs), but are not limited thereto. Furthermore, each of the transistors may have a structure formed by sequentially stacking a semiconductor layer, a gate electrode, source/drain electrodes with insulating layers interposed therebetween.

The substrate SUB and the pixel circuit layer PCL described above may be formed using semiconductor process and equipment, but are not limited thereto.

The light-emitting-element layer LDL disposed on the pixel circuit layer PCL may include light emitting elements LD (refer to FIG. 7) that emits light. Each of the light emitting elements LD may be disposed in the first to third sub-pixels SP1 to SP3 (refer to FIG. 7). The light emitting elements LD may emit light of different colors. The light emitting elements LD may emit light of the same color. For example, color filters of different colors may be disposed on the light emitting elements LD to allow the first to third sub-pixels SP1 to SP3 to emit light of different colors. However, the colors of light emitted from the light emitting elements LD are not limited.

The window layer WDL may be disposed on the display panel DP. For example, the window layer WDL may be disposed on the light-emitting-element layer LDL. The window layer WDL may protect the display panel DP from external scratches or impact. The window layer WDL may be optically transparent. For example, the window layer WDL may be formed of a glass substrate, a plastic film, a plastic substrate, or the like. Furthermore, although the window layer WDL is illustrated as a single layer, the window layer WDL may include multiple layers. For example, the window layer WDL may have a selected multilayer structure. The multilayer structure may be formed through a successive process or an adhesion process using an adhesive layer.

A touch sensor (not illustrated) may be further disposed between the display panel DP and the window layer WDL. The touch sensor may be directly disposed on a surface of the display panel DP from which an image is displayed, to receive touch input from a user.

FIG. 7 is a schematic plan view illustrating an embodiment of light emitting elements included in sub-pixels of FIG. 1.

Referring to FIG. 7, one pixel PXL may include first to third sub-pixels SP1 to SP3. At least one of the first to third sub-pixels SP1 to SP3 may emit light of a different color from the others.

The first sub-pixel SP1 may include a first light emitting element LD1 that emits light in a first color. The first sub-pixel SP1 may include a first emission area EMA1 of the first light emitting element LD1, and a non-emission area NEA formed around the first emission area EMA1. The second sub-pixel SP2 may include a second light emitting element LD2 that emits light in a second color. The second sub-pixel SP2 may include a second emission area EMA2 of the second light emitting element LD2, and a non-emission area NEA formed around the second emission area EMA2. The third sub-pixel SP3 may include a third light emitting element LD3 that emits light in a third color. The third sub-pixel SP3 may include a third emission area EMA3 of the third light emitting element LD3, and a non-emission area NEA formed around the third emission area EMA3.

The first sub-pixel SP1 and the second sub-pixel SP2 may be spaced apart from each other in the second direction DR2. The third sub-pixel SP3 may be disposed adjacent to the first and second sub-pixels SP1 and SP2 in the first direction with respect to each of the first and second sub-pixels SP1 and SP2. However, embodiments are not limited to the aforementioned example. For example, the first to third sub-pixels SP1 to SP3 may be arranged in parallel in the first direction DR1.

The second light emitting element LD2 of the second sub-pixel SP2 may have a surface area equal to or greater than the surface area of the first light emitting element LD1 of the first sub-pixel SP1. The third light emitting element LD3 of the third sub-pixel SP3 may have a surface area greater than the surface area of the second light emitting element LD2 of the second sub-pixel SP2. Therefore, the second emission area EMA2 may have a surface area equal to or greater than the surface area of the first emission area EMA1. The third emission area EMA3 may have a surface area greater than the surface area of the second emission area EMA2. However, embodiments are not limited to the aforementioned example. For example, the second light emitting element LD2 of the second sub-pixel SP2 may have a surface area greater than the surface area of the first light emitting element LD1 of the first sub-pixel SP1.

As such, the arrangement or shape of the first to third sub-pixels SP1 to SP3 may be changed in various ways depending on embodiments. For example, the shape of the each of the first to third sub-pixels SP1, SP2, and SP3 may have a circular shape, a triangular shape, or other polygonal shapes.

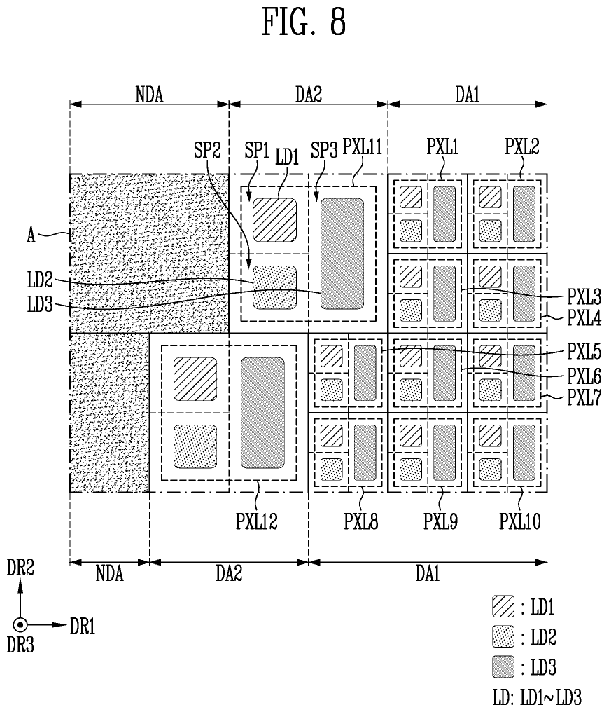

FIG. 8 is an enlarged schematic view illustrating portion A of FIG. 4, in accordance with embodiments of the display panel.

Referring to FIG. 8, the display panel DP may include pixels PXL1 to PXL10 disposed in the first display area DA1 and pixels PXL11 and PXL12 disposed in the second display area DA2.

Each of the first to tenth pixels PXL1 to PXL10 may include first to third light emitting elements LD1 to LD3 corresponding to a first resolution. For example, the first pixel PXL1 may include one first sub-pixel SP1, one second sub-pixel SP2, and one third sub-pixel SP3. The first sub-pixel SP1 may include a first light emitting element LD1 that emits light in a first color. The second sub-pixel SP2 may include a second light emitting element LD2 that emits light in a second color. The third sub-pixel SP3 may include a third light emitting element LD3 that emits light in a third color. The first color, the second color, and the third color may be different colors. For example, the first color may be red, the second color may be green, and the third color may be blue. However, the first to third colors are not limited to red, green, and blue, respectively.

The second display area DA2 of the display panel DP may be positioned between the first display area DA1 and the non-display area NDA. The eleventh and twelfth pixels PXL11 and PXL12 may be disposed in the second display area DA2 of the display panel DP. Each of the eleventh and twelfth pixels PXL11 and PXL12 may include first to third light emitting elements LD1 to LD3 corresponding to a second resolution lower than the first resolution.

Each of the eleventh and twelfth pixels PXL11 and PXL12 in the second display area DA2 may have equal light emitting element arrangement structure as any one of the first to tenth pixels PXL1 to PXL10 in the first display area DA1. However, the first to tenth pixels PXL1 to PXL10 and the eleventh and twelfth pixels PXL11 and PXL12 may have different pixel surface areas.

For example, each of the first to tenth pixels PXL1 to PXL10 disposed in the first display area DA1 may have a first surface area. Each of the eleventh and twelfth pixels PXL11 and PXL12 disposed in the second display area DA2 may have a second surface area greater than the first surface area. The second surface area may be substantially fourth times larger than the first surface area. For example, the surface area of the eleventh pixel PXL11 may have substantially equal to the sum of the surface areas of the first to fourth pixels PXL1 to PXL4. For example, the eleventh pixel PXL11 may have a same size of the first to fourth pixels PXL1 to PXL4 that are arranged in a 2×2 matrix form. The surface area of the twelfth pixel PXL12 may have substantially equal as the sum of the surface areas of the first to fourth pixels PXL1 to PXL4. For example, the twelfth pixel PXL12 may have a same size of the first to fourth pixels PXL1 to PXL4 that are arranged in a 2×2 matrix form.

Each of the eleventh and twelfth pixels PXL11 and PXL12 may have a larger surface area than any one of the first to tenth pixels PXL1 to PXL10. Therefore, the number of light emitting elements that can be disposed per unit surface area may vary. For example, in comparison of the numbers of light emitting elements in the same surface area, the number of light emitting elements included in the eleventh pixel PXL11 may be less than the number of light emitting elements included in the first to fourth pixels PXL1 to PXL4. For example, the eleventh pixel PXL11 may include one first light emitting element LD1, one second light emitting element LD2, and one third light emitting element LD3. The eleventh pixel PXL11 may include a total of three light emitting elements. On the other hand, the first to fourth pixels PXL1 to PXL4 having a same surface area as the eleventh pixel PXL11 may include four first light emitting elements LD1, four second light emitting elements LD2, and four third light emitting elements LD3. The first to fourth pixels PXL1 to PXL4 may include a total of twelve light emitting elements LD.

Referring to FIG. 8, the first to tenth pixels PXL1 to PXL10 disposed in the first display area DA1 and the eleventh and twelfth pixels PXL11 and PXL12 disposed in the second display area DA2 may include light emitting elements of different sizes. For example, in comparison of the emission areas of the light emitting elements that emit light of the same color in unit pixels, the light emitting elements LD disposed in unit pixel in the second display area DA2 may have a larger emission area than the light emitting elements LD disposed in unit pixel in the first display area DA1. For example, the first light emitting element LD1 of the eleventh pixel PXL11 may have a size greater than the size of the first light emitting element LD1 of the first pixel PXL1. The second light emitting element LD2 of the eleventh pixel PXL11 may have a size greater than the size of the second light emitting element LD2 of the first pixel PXL1. The third light emitting element LD3 of the eleventh pixel PXL11 may have a size greater than the size of the third light emitting element LD3 of the first pixel PXL1.

The display panel DP may include the first display area DA1 and the second display area DA2 having a resolution lower than that of the first display area DA1. Consequently, resources for driving signals and/or voltages required in the second display area DA2 may be reduced.

However, a difference in luminance between the first and second display areas DA1 and DA2 may occur, which may be perceived by a user. The difference in luminance between the first and second display areas DA1 and DA2 may be compensated for by rendering some of the data units of the input image data.

FIG. 9 is a schematic diagram illustrating an embodiment of data units used in the rendering block of FIG. 2. In FIG. 9, for the sake of convenience in explanation, there are illustrated data sets corresponding to the first to fourth pixels PXL1 to PXL4 and the eleventh pixel PXL11.

Referring to FIG. 9, the input image data DATA1 (refer to FIG. 2) may include data units DU_R1 to DU_R8, DU_G1 to DU_G8, and DU_B1 to DU_B8 corresponding to pixel rows ROW1 and ROW2 and pixel columns COL1 to COL12. The data units DU_R1 to DU_R8, DU_G1 to DU_G8, and DU_B1 to DU_B8 may correspond to input grayscale values of sub-pixels. The data units DU_R1 to DU_R8, DU_G1 to DU_G8, and DU_B1 to DU_B8 of the input image data DATA1 may have substantially equal resolution.

The data units DU_R1 to DU_R8, DU_G1 to DU_G8, and DU_B1 to DU_B8 may be divided into first data sets DTS1 and a second data set DTS2. For example, each of the first data sets DTS1 may include one data unit corresponding to the first color, one data unit corresponding to the second color, and one data unit corresponding to the third color. For example, a first data set DTS1 may include data units DU_R3, DU_G3, and DU_B3 corresponding to the seventh to ninth pixel columns COL7 to COL9 of the first pixel row ROW1. Another first data set DTS1 may include data units DU_R4, DU_G4, and DU_B4 corresponding to the tenth to twelfth pixel columns COL10 to COL12 of the first pixel row ROW1. Another first data set DTS1 may include data units DU_R7, DU_G7, and DU_B7 corresponding to the seventh to ninth pixel columns COL7 to COL9 of the second pixel row ROW2. Another first data set DTS1 may include data units DU_R8, DU_G8, and DU_B8 corresponding to the tenth to twelfth pixel columns COL10 to COL12 of the second pixel row ROW2. In FIG. 8, each of the dotted boxes, each including three data units, may be understood as a first data set DTS1.

The second data set DTS2 may include four data units corresponding to the first color, four data units corresponding to the second color, and four data units corresponding to the third color. For example, the second data set DTS2 may include data units DU_R1, DU_G1, DU_B1, DU_R2, DU_G2, DU_B2, DU_R5, DU_G5, DU_B5, DU_R6, DU_G6, and DU_B6 corresponding to the first to sixth pixel columns COL1 to COL6 of the first pixel row ROW1 and the second pixel row ROW2.

Referring to FIGS. 8 and 9, the first and second data sets DTS1 and DTS2 may correspond to each of the pixels. For example, the data units DU_R3, DU_G3, and DU_B3 included in one of the first data sets DTS1 may respectively correspond to the light emitting elements LD1 to LD3 of the first pixel PXL1. The data units DU_R4, DU_G4, and DU_B4 included in another of the first data sets DTS1 may respectively correspond to the light emitting elements LD1 to LD3 of the second pixel PXL2. The data units DU_R7, DU_G7, and DU_B7 included in another of the first data sets DTS1 may respectively correspond to the light emitting elements LD1 to LD3 of the third pixel PXL3. The data units DU_R8, DU_G8, and DU_B8 included in another of the first data sets DTS1 may respectively correspond to the light emitting elements LD1 to LD3 of the fourth pixel PXL4.

The data units DU_R1, DU_G1, DU_B1, DU_R2, DU_G2, DU_B2, DU_R5, DU_G5, DU_B5, DU_R6, DU_G6, and DU_B6 included in the second data set DTS2 may correspond to the light emitting elements LD1 to LD3 of the eleventh pixel PXL11. The data units DU_R1, DU_G1, DU_B1, DU_R2, DU_G2, DU_B2, DU_R5, DU_G5, DU_B5, DU_R6, DU_G6, and DU_B6 included in the second data set DTS2 may be rendered by the rendering block 152 (refer to FIG. 2) of the controller 150. The light emitting elements LD1 to LD3 of the eleventh pixel PXL11 may be driven according to rendered data.

FIG. 10 is a schematic diagram illustrating an example where data units rendered in the rendering block 152 of FIG. 2 are generated.

Referring to FIGS. 2 and 10, the controller 150 may generate rendering data RDATA for pixels with a relatively low resolution by rendering the input image data DATA1 using the rendering block 152.

The controller 150 may generate a third data set DTS3 by rendering the data units included in the second data set DTS2. The controller 150 may generate the third data set DTS3 by mixing data units for a same color among the data units included in the second data set DTS2.

For example, the controller 150 may generate a rendered data unit RDU_R for the first color by mixing the data units DU_R1, DU_R2, DU_R5, and DU_R6 for the first color included in the second data set DTS2. For example, the controller 150 may generate the rendered data unit RDU_R for the first color by calculating an average of input grayscale values of the data units DU_R1, DU_R2, DU_R5, and DU_R6 for the first color included in the second data set DTS2. The rendered data unit RDU_R for the first color may be an output grayscale value corresponding to the first light emitting element LD1 (refer to FIG. 8) of the eleventh pixel PXL11 (refer to FIG. 8). Therefore, the first light emitting element LD1 of the eleventh pixel PXL11 may be driven by the rendered data unit RDU_R for the first color.

The controller 150 may generate a rendered data unit RDU_G for the second color by mixing the data units DU_G1, DU_G2, DU_G5, and DU_G6 for the second color included in the second data set DTS2. For example, the controller 150 may generate the rendered data unit RDU_G for the second color by calculating an average of input grayscale values of the data units DU_G1, DU_G2, DU_G5, and DU_G6 for the second color included in the second data set DTS2. The rendered data unit RDU_G for the second color may be an output grayscale value corresponding to the second light emitting element LD2 (refer to FIG. 8) of the eleventh pixel PXL11. Therefore, the second light emitting element LD2 of the eleventh pixel PXL11 may be driven by the rendered data unit RDU_G for the second color.

The controller 150 may generate a rendered data unit RDU_B for the third color by mixing the data units DU_B1, DU_B2, DU_B5, and DU_B6 for the third color included in the second data set DTS2. For example, the controller 150 may generate the rendered data unit RDU_B for the third color by calculating an average of input grayscale values of the data units DU_B1, DU_B2, DU_B5, and DU_B6 for the third color included in the second data set DTS2. The rendered data unit RDU_B for the third color may be an output grayscale value corresponding to the third light emitting element LD3 (refer to FIG. 8) of the eleventh pixel PXL11. Therefore, the third light emitting element LD3 of the eleventh pixel PXL11 may be driven by the rendered data unit RDU_B for the third color.

The rendered data unit RDU_R for the first color, the rendered data unit RDU_G for the second color, and the rendered data unit RDU_B for the third color may be included in the third data set DTS3.

Output grayscale values of the rendered data units RDU_R, RDU_G, and RDU_B included in the third data set DTS3 may be calculated as shown in Equation 1.

$$R \_ R = ( R 1 + R 2 + R 3 + R 4 ) / 4 \qquad [ Equation 1 ]$$

$$R \_ G = ( G 1 + G 2 + G 3 + G 4 ) / 4$$

$$R \_ B = \{ B 1 + B 2 + B 3 + B 4 ) / 4$$

Referring to Equation 1, R1 may denote an input grayscale value of the first data unit DU_R1 of the first color, R2 may denote an input grayscale value of the second data unit DU_R2 of the first color, R3 may denote an input grayscale value of the fifth data unit DU_R5 of the first color, and R4 may denote an input grayscale value of the sixth data unit DU_R6 of the first color. R_R may denote an output grayscale value of the rendered data unit RDU_R of the first color. G1 may denote an input grayscale value of the first data unit DU_G1 of the second color, G2 may denote an input grayscale value of the second data unit DU_G2 of the second color, G3 may denote an input grayscale value of the fifth data unit DU_G5 of the second color, and G4 may denote an input grayscale value of the sixth data unit DU_G6 of the second color. R_G may denote an output grayscale value of the rendered data unit RDU_G of the second color. B1 may denote an input grayscale value of the first data unit DU_B1 of the third color, B2 may denote an input grayscale value of the second data unit DU_B2 of the third color, B3 may denote an input grayscale value of the fifth data unit DU_B5 of the third color, and B4 may denote an input grayscale value of the sixth data unit DU_B6 of the third color. R_B may denote an output grayscale value of the rendered data unit RDU_B of the third color.

As the data units of the input image data that correspond to the second display area DA2 are rendered and provided, substantially equal luminance may be maintained in the first and second display areas DA1 and DA2, thereby improving display quality. For example, an average of the input grayscale values of the data units corresponding to the second display area DA2 may be calculated and then provided to pixels disposed in the second display area DA2. Thereby, a difference in luminance that occurs in case that the resolution of the second display area DA2 is lower than the resolution of the first display area DA1 may be compensated for.

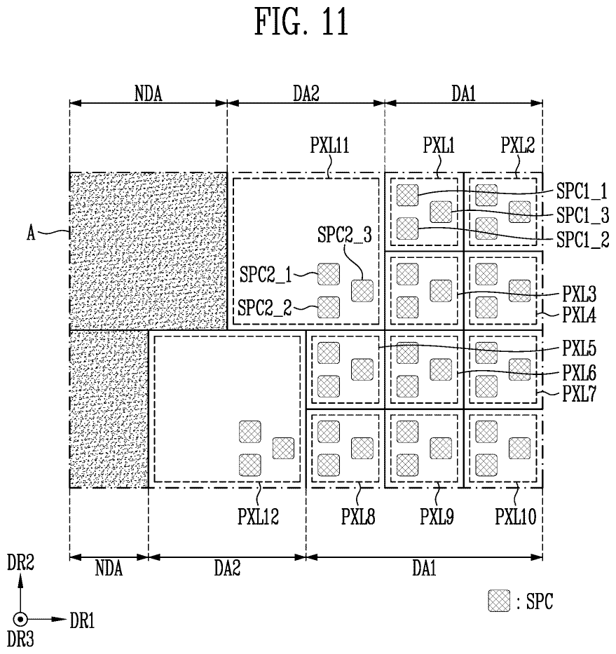

FIG. 11 is a schematic diagram illustrating arrangement of sub-pixel circuits in accordance with an embodiment of FIG. 8.

Referring to FIGS. 8 and 11, the first to tenth pixels PXL1 to PXL10 disposed in the first display area DA1 may include sub-pixel circuits SPC1_1 to SPC1_3 to drive the first to third light emitting elements LD1 to LD3. The first display area DA1 may include a total of three sub-pixel circuits for each unit pixel.

The first pixel PXL1 may include first to third sub-pixel circuits SPC1_1 to SPC1_3. Each of the first to third sub-pixel circuits SPC1_1 to SPC1_3 may include multiple transistors and at least one capacitor.

For example, the first to third sub-pixel circuits SPC1_1 to SPC1_3 of the first pixel PXL1 may overlap the first to third light emitting elements LD1 to LD3 of the first pixel PXL1 in a plan view. For example, the first sub-pixel circuit SPC1_1 of the first pixel PXL1 may be disposed under the first light emitting element LD1 of the first pixel PXL1. The second sub-pixel circuit SPC1_2 of the first pixel PXL1 may be disposed under the second light emitting element LD2 of the first pixel PXL1. The third sub-pixel circuit SPC1_3 of the first pixel PXL1 may be disposed under the third light emitting element LD3 of the first pixel PXL1. The sub-pixel circuits of the second to tenth pixels PXL2 to PXL10 may be configured in a same manner as the first pixel PXL1.

Each of the eleventh and twelfth pixels PXL11 and PXL12 disposed in the second display area DA2 may include sub-pixel circuits SPC2_1 to SPC2_3 to drive the first to third light emitting elements LD1 to LD3. The second display area DA2 may include a total of three sub-pixel circuits for each unit pixel. Each of the sub-pixel circuits SPC2_1 to SPC2_3 disposed in the second display area DA2 may have a same circuit structure as any one of the sub-pixel circuits SPC1_1 to SPC1_3 disposed in the first display area DA1.

The eleventh pixel PXL11 may include first to third sub-pixel circuits SPC2_1 to SPC2_3. Each of the first to third sub-pixel circuits SPC2_1 to SPC2_3 may include multiple transistors and at least one capacitor.

For example, each of the first to third sub-pixel circuits SPC2_1 to SPC2_3 of the eleventh pixel PXL11 may drive the first to third light emitting elements LD1 to LD3 of the eleventh pixel PXL11. For example, the first sub-pixel circuit SPC2_1 of the eleventh pixel PXL11 may be a sub-pixel circuit to drive the first light emitting element LD1 of the eleventh pixel PXL11. The second sub-pixel circuit SPC2_2 of the eleventh pixel PXL11 may be a sub-pixel circuit to drive the second light emitting element LD2 of the eleventh pixel PXL11. The third sub-pixel circuit SPC2_3 of the eleventh pixel PXL11 may be a sub-pixel circuit to drive the third light emitting element LD3 of the eleventh pixel PXL11. The sub-pixel circuits of the twelfth pixel PXL12 may be configured in a same manner as the eleventh pixel PXL11.

Referring to FIGS. 8 and 11, since each of the eleventh and twelfth pixels PXL11 and PXL12 has a surface area greater than the surface area of any one of the first to tenth pixels PXL1 to PXL10, the number of pixels that can be disposed per unit surface area may vary. Therefore, the number of sub-pixel circuits that can be disposed per unit surface area may also vary. For example, in comparison of the number of sub-pixel circuits in a same surface area between the first display area DA1 and the second display area DA2, the number of sub-pixel circuits SPC2_1 to SPC2_3 included in the eleventh pixel PXL11 may be less than the number of sub-pixel circuits SPC1_1 to SPC1_3 included in the first to fourth pixels PXL1 to PXL4. For example, the eleventh pixel PXL11 may include one first sub-pixel circuit SPC2_1, one second sub-pixel circuit SPC2_2, and one third sub-pixel circuit SPC2_3. The eleventh pixel PXL11 may include a total of three sub-pixel circuits. On the other hand, the first to fourth pixels PXL1 to PXL4 having the same surface area as the eleventh pixel PXL11 may include four first sub-pixel circuits SPC1_1, four first sub-pixel circuits SPC1_2, and four first sub-pixel circuits SPC1_3. The first to fourth pixels PXL1 to PXL4 may include a total of twelve sub-pixel circuits.

The number of transistors that may be disposed per unit surface area may vary. For example, in comparison of the number of transistors in a same surface area between the first display area DA1 and the second display area DA2, the number of transistors included in the eleventh pixels PXL11 may be less than the number of transistors included in the first to fourth pixels PXL1 to PXL4 having a same surface area as the eleventh pixel PXL11.

Therefore, the surface area of the sub-pixel circuits SPC2_1 to SPC2_3 in the second display area DA2 may be equal to or less than the surface area of the sub-pixel circuits SPC1_1 to SPC1_3 in the first display area DA1. Consequently, space where signal lines electrically connected to the sub-pixel circuits SPC2_1 to SPC2_3 are disposed may also be reduced. As a result, the surface area of dead space caused by the sub-pixel circuits to drive the light emitting elements in the second display area DA2 may be minimized.

The sub-pixel circuits SPC2_1 to SPC2_3 of the eleventh pixel PXL11 may be changed in various ways in the eleventh pixel PXL11. For example, the sub-pixel circuits SPC2_1 to SPC2_3 of the eleventh pixel PXL11 may be disposed under the second light emitting element LD2 of the eleventh pixel PXL11.

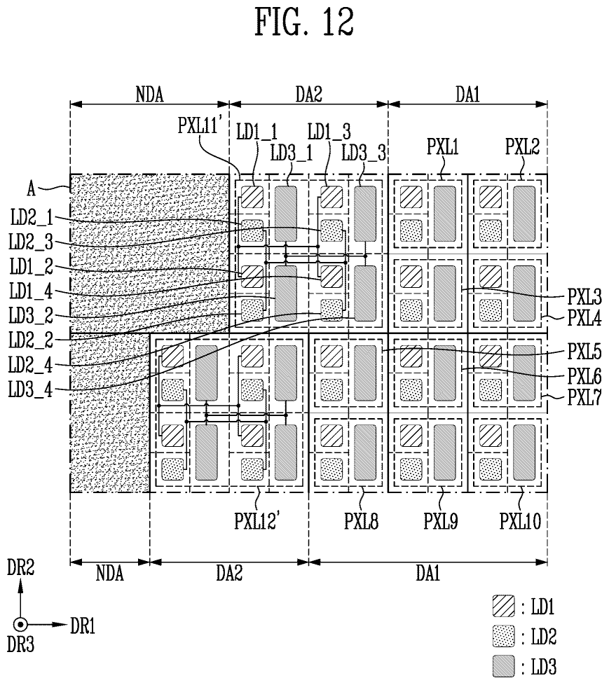

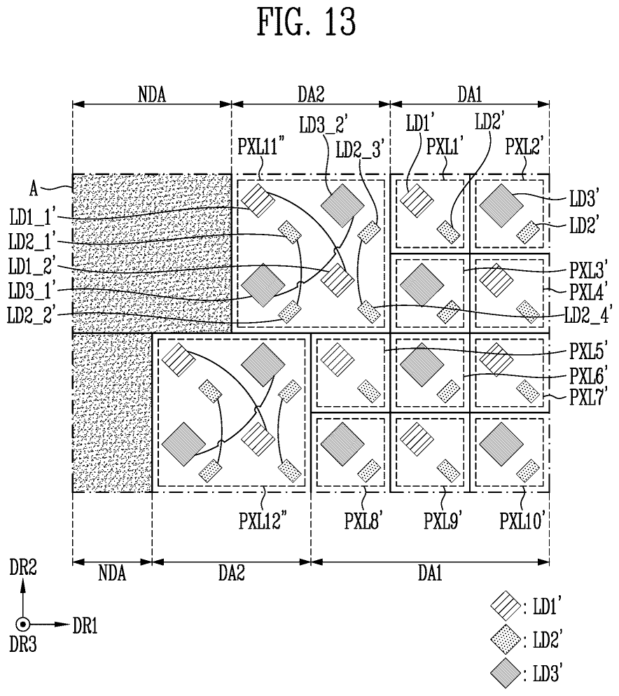

FIGS. 12 and 13 are schematic enlarged views illustrating portion A of FIG. 4, in accordance with other embodiments of the display panel.

Referring to FIG. 12, the first to tenth pixels PXL1 to PXL10 disposed in the first display area DA1 may be described in an equal manner as the embodiments of FIG. 8. Hereinafter, redundant explanations related to the embodiments of FIG. 8 will be omitted, and differences from the aforementioned embodiments will be primarily described.

Eleventh and twelfth pixels PXL11′ and PXL12′ may be disposed in the second display area DA2 of the display panel DP. In the eleventh and twelfth pixels PXL11′ and PXL12′, light emitting elements that emit light in a same color in each of the pixels may be electrically connected to each other. Therefore, light emitting elements that are electrically connected to each other may receive a same signal and emit light with substantial equal luminance.

Each of the eleventh and twelfth pixels PXL11′ and PXL12′ in the second display area DA2 may have a same light emitting element arrangement as pixels arranged in a 2×2 matrix form among the first to tenth pixels PXL1 to PXL10 in the first display area DA1. Therefore, the number of light emitting elements that are disposed per unit surface area may be equal. However, some light emitting elements that emit light in a same color among the light emitting elements of the eleventh and twelfth pixels PXL11′ and PXL12′ may be electrically connected to each other.

For example, the surface area of the eleventh pixel PXL11′ disposed in the second display area DA2 may have substantially equal size as the sum of the surface areas of the first to fourth pixels PXL1 to PXL4. The eleventh pixel PXL11′ may have substantially equal size as the first to fourth pixels PXL1 to PXL4 that are arranged in a 2×2 matrix form.

In comparison of the number of light emitting elements in a same surface area, the number of light emitting elements included in the eleventh pixel PXL11′ may be equal to the number of light emitting elements included in the first to fourth pixels PXL1 to PXL4. For example, the eleventh pixel PXL11′ may include four first light emitting elements LD1_1 to LD1_4, four second light emitting elements LD2_1 to LD2_4, and four third light emitting elements LD3_1 to LD3_4. The eleventh pixel PXL11′ may include a total of twelve light emitting elements. The first to fourth pixels PXL1 to PXL4 having a same surface area as the eleventh pixel PXL11′ may include four first light emitting elements LD1, four second light emitting elements LD2, and four third light emitting elements LD3. The first to fourth pixels PXL1 to PXL4 may include a total of twelve light emitting elements.

In comparison of the surface area of the light emitting elements in a same surface area, the surface area of the light emitting elements included in the eleventh pixel PXL11′ may be equal to the surface area of the light emitting elements included in the first to fourth pixels PXL1 to PXL4.

However, in comparison of the number of light emitting elements in unit pixel, the number of light emitting elements included in each of the eleventh and twelfth PXL11′ and PXL12′ may be greater than the number of light emitting elements included in any one of the first to fourth pixels PXL1 to PXL4. For example, the eleventh pixel PXL11′ may include four first light emitting elements LD1_1 to LD1_4, four second light emitting elements LD2_1 to LD2_4, and four third light emitting elements LD3_1 to LD3_4. On the other hand, the first pixel PXL1 may include one first light emitting element LD1, one second light emitting element LD2, and one third light emitting element LD3.

In comparison of the surface area of the light emitting elements in unit pixel, the surface area of the light emitting elements included in each of the eleventh and twelfth PXL11′ and PXL12′ may be greater than the surface area of the light emitting elements included in any one of the first to fourth pixels PXL1 to PXL4. For example, the surface area of the light emitting elements included in the eleventh pixel PXL11′ may be greater than the surface area of the light emitting elements included in the first pixel PXL1. The surface area of the light emitting elements included in the eleventh pixel PXL11′ may be substantially four times greater than the surface area of the light emitting elements included in the first pixel PXL1.

In the eleventh and twelfth pixels PXL11′ and PXL12′ disposed in the second display area DA2, light emitting elements that emit light in the same color in each of the pixels may be electrically connected to each other. For example, included in the eleventh pixel PXL11′, the first light emitting elements LD1_1 to LD1_4 that emit light in the first color may be electrically connected to each other, and may be driven in common or together. For example, the anode electrodes AE (refer to FIG. 3) of the corresponding light emitting elements may be electrically connected to each other. The first light emitting elements LD1_1 to LD1_4 electrically connected to each other in the eleventh pixel PXL11′ may have an emission area greater than the emission area of the first light emitting element LD1 of the first pixel PXL1 disposed in the first display area DA1.

Included in the eleventh pixel PXL11′, the second light emitting elements LD2_1 to LD2_4 that emit light in the second color may be electrically connected to each other, and may be driven together. The second light emitting elements LD2_1 to LD2_4 electrically connected to each other in the eleventh pixel PXL11′ may have an emission area greater than the emission area of the second light emitting element LD2 of the first pixel PXL1 disposed in the first display area DA1.

Included in the eleventh pixel PXL11′, the third light emitting elements LD3_1 to LD3_4 that emit light in the third color may be electrically connected to each other, and may be driven together. The third light emitting elements LD3_1 to LD3_4 electrically connected to each other in the eleventh pixel PXL11′ may have an emission area greater than the emission area of the third light emitting element LD3 of the first pixel PXL1 disposed in the first display area DA1.

Referring to FIG. 13, the display panel DP may have an RGBG pixel arrangement or a Pentile® pixel arrangement. For example, the display panel DP may have first light emitting elements LD1′ and third light emitting elements LD3′ that are repeatedly arranged in the first direction DR1 and the second direction DR2 in the first display area DA1. Second light emitting elements LD2′ may be disposed in a diagonal direction based on the first light emitting element LD1′ and the third light emitting element LD3′ in the first display area DA1.

Eleventh and twelfth pixels PXL11″ and PXL12″ may be disposed in the second display area DA2 of the display panel DP.

Each of the eleventh and twelfth pixels PXL11″ and PXL12″ in the second display area DA2 may have a same light emitting element arrangement as the first to tenth pixels PXL1′ to PXL10′ in the first display area DA1. Therefore, the number of light emitting elements that can be disposed per unit surface area may be equal. However, some light emitting elements that emit light in the same color among the light emitting elements of the eleventh and twelfth pixels PXL11″ and PXL12″ may be electrically connected to each other.

For example, the number of light emitting elements included in the eleventh pixel PXL11″ in the second display area DA2 may be a same as the number of light emitting elements included in the first to fourth pixels PXL1′ to PXL4′. For example, the eleventh pixel PXL11″ may include two first light emitting elements LD1_1′ to LD1_2′, four second light emitting elements LD2_1′ to LD2_4′, and two third light emitting elements LD3_1′ and LD3_2′. The first pixel PXL1′ may include one first light emitting element LD1′ and one second light emitting element LD2′. The second pixel PXL2′ may include one second light emitting element LD2′ and one third light emitting element LD3′. The third pixel PXL3′ may include one second light emitting element LD2′ and one third light emitting element LD3′. The fourth pixel PXL4′ may include one first light emitting element LD1′ and one second light emitting element LD2′. The first to fourth pixels PXL1′ to PXL4′ having equal surface area as the eleventh pixel PXL11″ may include a same number of light emitting elements as the eleventh pixels PXL11″ such as two first light emitting elements LD1′, four second light emitting elements LD2′, and two third light emitting elements LD3′.

In the eleventh and twelfth pixels PXL11″ and PXL12″ disposed in the second display area DA2, light emitting elements that emit light in a same color in each of the pixels may be electrically connected to each other. For example, included in the eleventh pixel PXL11″, the first light emitting elements LD1_1′ and LD1_2′ that emit light in the first color may be electrically connected to each other. The first light emitting elements LD1_1′ and LD1_2′ in the eleventh pixel PXL11″ may have an emission area greater than the emission area of the first light emitting element LD1′ of the first pixel PXL1′ in the first display area DA1.

Some second light emitting elements LD2_1′ and LD2_2′ among the second light emitting elements LD2_1′ to LD2_4′ included in the eleventh pixel PXL11″ that emits light in the second color may be electrically connected to each other. The second light emitting elements LD2_1′ and LD2_2′ in the eleventh pixel PXL11″ may have an emission area greater than the emission area of the second light emitting element LD2′ of the first pixel PXL1′ in the first display area DA1.

Other second light emitting elements LD2_3′ and LD2_4′ among the second light emitting elements LD2_1′ to LD2_4′ included in the eleventh pixel PXL11″ that emits light in the second color may be electrically connected to each other. The second light emitting elements LD2_3′ and LD2_4′ in the eleventh pixel PXL11″ may have an emission area greater than the emission area of the second light emitting element LD2′ of the second pixel PXL2′ in the first display area DA1.

Included in the eleventh pixel PXL11″, the third light emitting elements LD3_1′ and LD3_2′ that emit light in the third color may be electrically connected to each other. The third light emitting elements LD3_1′ and LD3_2′ in the eleventh pixel PXL11″ may have an emission area greater than the emission area of the third light emitting element LD3′ of the second pixel PXL2′ in the first display area DA1.

As such, in each unit pixel disposed in the second display area DA2, the light emitting elements that emit light in a same color may be electrically connected to each other, and thus be electrically connected to a same sub-pixel circuit to receive a same signal. Consequently, the light emitting elements that are electrically connected to each other may be driven together according to the rendered data units and have substantially equal luminance.

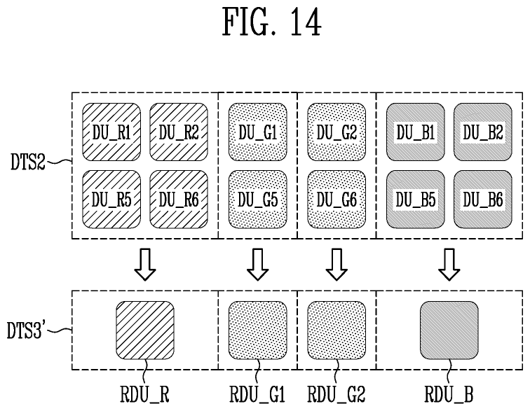

FIG. 14 is a schematic diagram illustrating an example where data units rendered in the rendering block 152 of FIG. 2 are generated, in accordance with an embodiment of FIG. 13.

Referring to FIGS. 2 and 14, the controller 150 may generate rendering data RDATA according to a Pentile® pixel arrangement by rendering the input image data DATA1 using the rendering block 152.

The controller 150 may generate a third data set DTS3′ by rendering the data units included in the second data set DTS2. The controller 150 may generate the third data set DTS3′ by mixing data units for equal colors among the data units included in the second data set DTS2. However, the third data set DTS3′ may include rendered data units RDU_R, RDU_G1, RDU_G2, and RDU_B in a Pentile® pixel arrangement.

For example, the controller 150 may generate a rendered data unit RDU_R for the first color by mixing the data units DU_R1, DU_R2, DU_R5, and DU_R6 for the first color included in the second data set DTS2. For example, the controller 150 may generate the rendered data unit RDU_R for the first color by calculating an average of input grayscale values of the data units DU_R1, DU_R2, DU_R5, and DU_R6 for the first color included in the second data set DTS2. The rendered data unit RDU_R for the first color may be an output grayscale value corresponding to the first light emitting elements LD1_1′ and LD1_2′ (refer to FIG. 13) of the eleventh pixel PXL11″ (refer to FIG. 13). Therefore, the first light emitting elements LD1_1′ and LD1_2′ of the eleventh pixel PXL11″ may be driven together by the rendered data unit RDU_R for the first color.

The controller 150 may generate a rendered data unit RDU_B for the third color by mixing the data units DU_B1, DU_B2, DU_B5, and DU_B6 for the third color included in the second data set DTS2. For example, the controller 150 may generate the rendered data unit RDU_B for the third color by calculating an average of input grayscale values of the data units DU_B1, DU_B2, DU_B5, and DU_B6 for the third color included in the second data set DTS2. The rendered data unit RDU_B for the third color may be an output grayscale value corresponding to the third light emitting elements LD3_1′ and LD3_2′ (refer to FIG. 13) of the eleventh pixel PXL11″. Therefore, the third light emitting elements LD3_1′ and LD3_2′ of the eleventh pixel PXL11″ may be driven in common or together by the rendered data unit RDU_B for the third color.

The controller 150 may generate a first rendered data unit RDU_G1 for the second color by mixing some data units DU_G1 and DU_G5 among the data units DU_G1, DU_G2, DU_G5, and DU_G6 for the second color included in the second data set DTS2. For example, the controller 150 may generate the first rendered data unit RDU_G1 for the second color by calculating an average of input grayscale values of the data units DU_G1 and DU_G5 among the data units DU_G1, DU_G2, DU_G5, and DU_G6 for the second color included in the second data set DTS2. The first rendered data unit RDU_G1 for the second color may be an output grayscale value corresponding to the second light emitting elements LD2_1′ and LD2_2′ (refer to FIG. 13) of the eleventh pixel PXL11″. Therefore, the second light emitting elements LD2_1′ and LD2_2′ of the eleventh pixel PXL11″ may be driven in common or together by the first rendered data unit RDU_G1 for the second color.

The controller 150 may generate a second rendered data unit RDU_G2 for the second color by mixing some other data units DU_G2 and DU_G6 among the data units DU_G1, DU_G2, DU_G5, and DU_G6 for the second color included in the second data set DTS2. For example, the controller 150 may generate the second rendered data unit RDU_G2 for the second color by calculating an average of input grayscale values of the data units DU_G2 and DU_G6 among the data units DU_G1, DU_G2, DU_G5, and DU_G6 for the second color included in the second data set DTS2. The second rendered data unit RDU_G2 for the second color may be an output grayscale value corresponding to the second light emitting elements LD2_3′ and LD2_4′ (refer to FIG. 13) of the eleventh pixel PXL11″. Therefore, the second light emitting elements LD2_3′ and LD2_4′ of the eleventh pixel PXL11″ may be driven in common or together by the second rendered data unit RDU_G2 for the second color.

The rendered data unit RDU_R for the first color, the first rendered data unit RDU_G1 for the second color, the second rendered data unit RDU_G2 for the second color, and the rendered data unit RDU_B for the third color may be included in the third data set DTS3′.

Output grayscale values of the rendered data units RDU_R, RDU_G1, RDU_G2, and RDU_B included in the third data set DTS3′ may be calculated as shown in Equation 2.

$$R \_ R = ( R 1 + R 2 + R 3 + R 4 ) / 4 \qquad [ Equation 2 ]$$

$$R \_ G 1 = ( G 1 + G 3 ) / 4$$

$$R \_ G 2 = ( G 2 + G 4 ) / 4$$

$$R \_ B = ( B 1 + B 2 + B 3 + B 4 ) / 4$$

Referring to Equation 2, R1 may denote an input grayscale value of the first data unit DU_R1 of the first color, R2 may denote an input grayscale value of the second data unit DU_R2 of the first color, R3 may denote an input grayscale value of the fifth data unit DU_R5 of the first color, and R4 may denote an input grayscale value of the sixth data unit DU_R6 of the first color. R_R may denote an output grayscale value of the rendered data unit RDU_R of the first color. G1 may denote an input grayscale value of the first data unit DU_G1 of the second color, G2 may denote an input grayscale value of the second data unit DU_G2 of the second color, G3 may denote an input grayscale value of the fifth data unit DU_G5 of the second color, and G4 may denote an input grayscale value of the sixth data unit DU_G6 of the second color. R_G1 may denote an output grayscale value of the first rendered data unit RDU_G1 of the second color. R_G2 may denote an output grayscale value of the second rendered data unit RDU_G2 of the second color. B1 may denote an input grayscale value of the first data unit DU_B1 of the third color, B2 may denote an input grayscale value of the second data unit DU_B2 of the third color, B3 may denote an input grayscale value of the fifth data unit DU_B5 of the third color, and B4 may denote an input grayscale value of the sixth data unit DU_B6 of the third color. R_B may denote an output grayscale value of the rendered data unit RDU_B of the third color.

The controller 150 may apply various known types of rendering algorithms related to the Pentile® pixel arrangement to the data units included in the first data set DTS1. For example, the rendering block 152 of the controller 150 may apply a rendering filter to the input image data DATA1 in RGB format to generate rendering data RDATA in RGBG format.

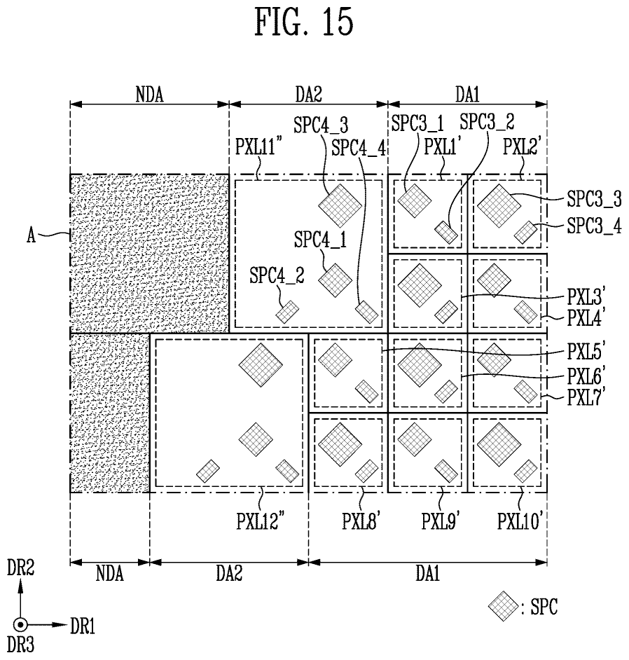

FIG. 15 is a schematic diagram illustrating arrangement of sub-pixel circuits in accordance with an embodiment of FIG. 13.

Referring to FIGS. 13 and 15, the first to tenth pixels PXL1′ to PXL10′ in the first display area DA1 may include a total of two sub-pixel circuits per unit pixel.

The first pixel PXL1′ may include first and second sub-pixel circuits SPC3_1 and SPC3_2. Each of the first and second sub-pixel circuits SPC3_1 and SPC3_2 may include multiple transistors and at least one capacitor to drive the first and second light emitting elements LD1′ and LD2′.

The first and second sub-pixel circuits SPC3_1 and SPC3_2 of the first pixel PXL1′ may overlap the first and second light emitting elements LD1′ and LD2′ of the first pixel PXL1′ in a plan view. For example, the first sub-pixel circuit SPC3_1 of the first pixel PXL1′ may be disposed under the first light emitting element LD1′ of the first pixel PXL1′. The second sub-pixel circuit SPC3_2 of the first pixel PXL1′ may be disposed under the second light emitting element LD2′ of the first pixel PXL1′.

The second pixel PXL2′ may include third and fourth sub-pixel circuits SPC3_3 and SPC3_4. Each of the third and fourth sub-pixel circuits SPC3_3 and SPC3_4 include multiple transistors and at least one capacitor to drive the third and second light emitting elements LD3′ and LD2′.

The third and fourth sub-pixel circuits SPC3_3 and SPC3_4 of the second pixel PXL2′ may overlap the third and second light emitting elements LD3′ and LD2′ of the second pixel PXL2′ in a plan view. For example, the third sub-pixel circuit SPC3_3 of the second pixel PXL2′ may be disposed under the third light emitting element LD3′ of the second pixel PXL2′. The fourth sub-pixel circuit SPC3_4 of the second pixel PXL2′ may be disposed under the second light emitting element LD2′ of the first pixel PXL1′. The sub-pixel circuits of the third to tenth pixels PXL3′ to PXL10′ may also be configured in a same manner as the sub-pixel circuits of the first and second pixels PXL1′ and PXL2′.

The eleventh and twelfth pixels PXL11″ and PXL12″ disposed in the second display area DA2 may include a total of four sub-pixel circuits per unit pixel. Each of the sub-pixel circuits SPC4_1 to SPC4_4 in the second display area DA2 may have a same circuit structure as any one of the sub-pixel circuits SPC3_1 to SPC3_4 in the first display area DA1.

The eleventh pixel PXL11″ may include first to fourth sub-pixel circuits SPC4_1 to SPC4_4. For example, the first sub-pixel circuit SPC4_1 of the eleventh pixel PXL11″ may be electrically connected to the first light emitting elements LD1_1′ and LD1_2′ of the eleventh pixel PXL11″ that are electrically connected to each other. The first light emitting elements LD1_1′ and LD1_2′ of the eleventh pixel PXL11″ may receive a same signal from the first sub-pixel circuit SPC4_1 of the eleventh pixel PXL11″.

The second sub-pixel circuit SPC4_2 of the eleventh pixel PXL11″ may be electrically connected to some second light emitting elements LD2_1′ and LD2_2′ among the electrically-connected second light emitting elements LD2_1′ to LD2_4′ of the eleventh pixel PXL11″. The second light emitting elements LD2_1′ and LD2_2′ among the second light emitting elements LD2_1′ to LD2_4′ of the eleventh pixel PXL11″ may receive a same signal from the second sub-pixel circuit SPC4_2 of the eleventh pixel PXL11″.

The third sub-pixel circuit SPC4_3 of the eleventh pixel PXL11″ may be electrically connected to the third light emitting elements LD3_1′ and LD3_2′ of the eleventh pixel PXL11″ that are electrically connected to each other. The third light emitting elements LD3_1′ and LD3_2′ of the eleventh pixel PXL11″ may receive a same signal from the third sub-pixel circuit SPC4_3 of the eleventh pixel PXL11″.

The fourth sub-pixel circuit SPC4_4 of the eleventh pixel PXL11″ may be electrically connected to some other second light emitting elements LD2_3′ and LD2_4′ among the electrically connected second light emitting elements LD2_1′ to LD2_4′ of the eleventh pixel PXL11″. The second light emitting elements LD2_3′ and LD2_4′ among the second light emitting elements LD2_1′ to LD2_4′ of the eleventh pixel PXL11″ may receive a same signal from the fourth sub-pixel circuit SPC4_4 of the eleventh pixel PXL11″.

Referring to FIGS. 13 and 15, as each of the eleventh and twelfth pixels PXL11″ and PXL12″ may have a surface area greater than the surface area of any one of the first to tenth pixels PXL1′ to PXL10′, the number of pixels that are disposed per unit surface area may vary. Therefore, the number of sub-pixel circuits that are disposed per unit surface area may also vary. For example, in comparison of the number of sub-pixel circuits in a same surface area, the number of sub-pixel circuits included in the eleventh pixel PXL11″ may be less than the number of sub-pixel circuits included in the first to fourth pixels PXL1′ to PXL4′. For example, the eleventh pixel PXL11″ may include one first sub-pixel circuit SPC4_1, one second sub-pixel circuit SPC4_2, one third sub-pixel circuit SPC4_3, and one fourth sub-pixel circuit SPC4_4. The eleventh pixel PXL11″ may include a total of four sub-pixel circuits. On the other hand, the first to fourth pixels PXL1′ to PXL4′ having a same surface area as the eleventh pixel PXL11″ may include two first sub-pixel circuits SPC3_1, two second sub-pixel circuits SPC3_2, two third sub-pixel circuits SPC3_3, and two fourth sub-pixel circuit SPC3_4. The first to fourth pixels PXL1′ to PXL4′ may include a total of eight sub-pixel circuits.

The number of transistors that can be disposed per unit surface area may vary. For example, in comparison of the number of transistors in a same surface area, the number of transistors included in the eleventh pixels PXL11″ may be less than the number of transistors included in the first to fourth pixels PXL1′ to PXL4′ having a same surface area as the eleventh pixel PXL11″.

Each of the sub-pixel circuits SPC4_1 to SPC4_4 disposed in the second display area DA2 may be electrically connected in common or together to the corresponding light emitting elements that are electrically connected to each other. Therefore, the second display area DA2 may be less than the first display area DA1 in the number of sub-pixel circuits disposed in a same surface area. In the second display area DA2, space where signal lines electrically connected to the sub-pixel circuits SPC4_1 to SPC4_4 are disposed may also be reduced. As a result, the surface area of dead space caused by the sub-pixel circuits to drive the light emitting elements in the second display area DA2 may be minimized.

Although FIG. 15 illustrates that the sub-pixel circuits SPC4_1 to SPC4_4 of the eleventh pixel PXL11″ are disposed in some area in the eleventh pixel PXL11″, embodiments are not limited thereto. Positions at which the sub-pixel circuits SPC4_1 to SPC4_4 of each of the eleventh pixel PXL11″ and the twelfth pixel PXL12″ are disposed may be changed in various ways according to embodiments.

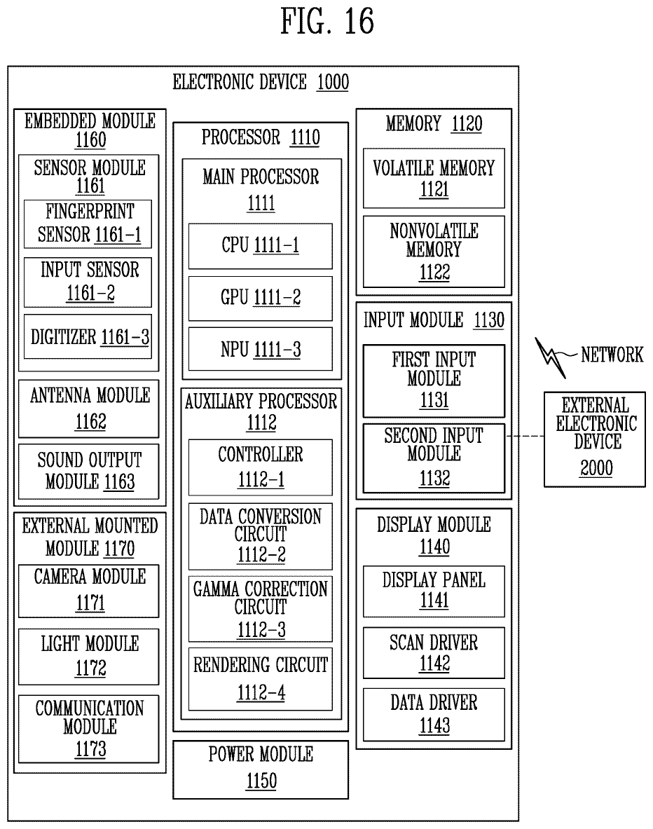

FIG. 16 is a schematic diagram illustrating an electronic device 1000 to which the display device in accordance with embodiments of the disclosure is applied.

Referring to FIG. 16, the electronic device 1000 may output various information through a display module 1140 in an operating system. The display module 1140 may correspond to at least a portion of the display device DD of FIG. 1. If a processor 1110 executes an application stored in a memory 1120, the display module 1140 may provide application information to the user through a display panel 1141.

The processor 1110 may acquire an external input through an input module 1130 or a sensor module 1161, and execute an application corresponding to the external input. For example, in the case where the user selects a camera icon displayed on the display panel 1141, the processor 1110 may obtain a user input through an input sensor 1161-2, and activate a camera module 1171. The processor 1110 may transmit image data corresponding to an image captured by the camera module 1171 to the display module 1140. The display module 1140 may display, on the display panel 1141, an image corresponding to the captured image.

As another example, in the case where personal information authentication is executed through the display module 1140, a fingerprint sensor 1161-1 may acquire inputted fingerprint information as input data. The processor 1110 may compare input data acquired through the fingerprint sensor 1161-1 with authentication data stored in the memory 1120, and may execute an application depending on a result of the comparison. The display module 1140 may display, on the display panel 1141, information executed according to the logic of the application.

As another example, in the case where a music streaming icon displayed on the display module 1140 is selected, the processor 1110 may acquire a user input through the input sensor 1161-2, and activate a music streaming application stored in the memory 1120. If a music playing command is inputted in the music streaming application, the processor 1110 may activate a sound output module 1163 and provide sound information corresponding to the music playing command to the user.

A brief description of the operation of the electronic device 1000 has been provided. Hereinafter, the configuration of the electronic device 1000 will be described in detail. Some of the components of the electronic device 1000 to be described below may be integrated into a single component, or one component may be separated into two or more components.

Referring to FIG. 16, the electronic device 1000 may communicate with an external electronic device 2000 through a network (e.g., a short-range wireless communication network or a long-range wireless communication network). The electronic device 1000 may include a processor 1110, a memory 1120, an input module 1130, a display module 1140, a power module 1150, an embedded module 1160, and an external mounted module 1170. In the electronic device 1000, at least one of the foregoing components may be omitted, or one or more other components may be added. Some components (e.g., the sensor module 1161, an antenna module 1162, or a sound output module 1163) among the foregoing components may be integrated into another component (e.g., the display module 1140).

The processor 1110 may execute software to control at least one other component (e.g., a hardware or software component) of the electronic device 1000 electrically connected to the processor 1110 and perform various data processing or computing operations. As at least a portion of a data processing or computing operation, the processor 1110 may store, in a volatile memory 1121, a command or data received from another component (e.g., the input module 1130, the sensor module 1161, or a communication module 1173), process the command or data stored in the volatile memory 1121, and store result data in a nonvolatile memory 1122.

The processor 1110 may include a main processor 1111 and an auxiliary processor 1112. The controller 150 of FIG. 1 may correspond to the main processor 1111 or the auxiliary processor 1112, or may be a function block for the main processor 1111 or the auxiliary processor 1112.

The main processor 1111 may include one or more of a central processing unit (CPU) 1111-1 and an application processor (AP). The main processor 1111 may further include any one or more of a graphic processing unit (GPU) 1111-2, a communication processor (CP), and an image signal processor (ISP). The main processor 1111 may further include a neural processing unit (NPU) 1111-3. The NPU may be a processor specialized to process an artificial intelligence model. The artificial intelligence model may be generated by machine learning. The artificial intelligence model may include multiple artificial neural network layers. An artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks, or a combination of two or more among the foregoing networks, but is not limited thereto. The artificial intelligence model may not only include a hardware structure but may also include an additional or substitutive software structure. At least two of the foregoing processing units and the processors may be implemented as a single integrated component (e.g., a single chip). In another example, the processing units and the processors may be implemented as respective independent components (e.g., multiple chips).

The auxiliary processor 1112 may include a controller 1112-1. The controller 1112-1 may include an interface conversion circuit and a timing control circuit. The controller 1112-1 may receive an image signal from the main processor 1111, and may convert a data format of the image signal to a format corresponding to specifications of an interface with the display module 1140 and output image data. The controller 1112-1 may output various control signals needed to drive the display module 1140. The auxiliary processor 1112 may be integrated into another component (e.g., the display module 1140).

The auxiliary processor 1112 may further include a data conversion circuit 1112-2, a gamma correction circuit 1112-3, a rendering circuit 1112-4, and the like. The data conversion circuit 1112-2 may receive image data from the controller 1112-1, compensate for the image data to display an image at a desired luminance based on characteristics of the electronic device 1000 or settings of the user, or may convert the image data to reduce power consumption or compensate for afterimages. The gamma correction circuit 1112-3 may convert image data, a gamma reference voltage, or the like so that an image to be displayed on the electronic device 1000 may have desired gamma characteristics. The rendering circuit 1112-4 may receive image data from the controller 1112-1, and render the image data taking into account pixel arrangement or the like on the display panel 1141 applied to the electronic device 1000. At least one of the data conversion circuit 1112-2, the gamma correction circuit 1112-3, and the rendering circuit 1112-4 may be integrated into another component (e.g., the main processor 1111 or the controller 1112-1). At least one of the data conversion circuit 1112-2, the gamma correction circuit 1112-3, and the rendering circuit 1112-4 may be integrated into a data driver 1143 to be described below.

The memory 1120 may store a variety of data to be used in at least one component (e.g., the processor 1110 or the sensor module 1161) of the electronic device 1000, and input data or output data for a command pertaining to the variety of data. The memory 1120 may include at least one or more of the volatile memory 1121 and the nonvolatile memory 1122.

The input module 1130 may receive a command or data to be used in a component (e.g., the processor 1110, the sensor module 1161, or the sound output module 1163) of the electronic device 1000 from an external device (e.g., the user or an external electronic device 2000) provided outside the electronic device 1000.

The input module 1130 may include a first input module 1131 that receives a command or data from the user, and a second input module 1132 that receives a command or data from the external electronic device 2000. The first input module 1131 may include a microphone, a mouse, a keyboard, a key (e.g., a button), or a pen (e.g., a passive pen or an active pen). The second input module 1132 may support a designated protocol that can be electrically connected to the external electronic device 2000 in a wired or wireless manner. The second input module 1132 may include a high definition multimedia interface (HDMI), a universal serial bus (USB) interface, an SD card interface, or an audio interface. The second input module 1132 may include a connector, e.g., an HDMI connector, a USB connector, an SD card connector, or an audio connector (e.g., a headphone connector), for physical connection with the external electronic device 2000.

The display module 1140 may provide visual information to the user. The display module 1140 may include a display panel 1141, a scan driver 1142, and a data driver 1143. The scan driver 1142 and the data driver 1143 may respectively correspond to the gate driver 120 and the data driver 130 of FIG. 1. The display module 1140 may further include a window, a chassis, and a bracket to protect the display panel 1141.

The display panel 1141 may include a liquid crystal display panel, an organic light emitting display panel, or an inorganic light emitting display panel. The type of display panel 1141 is not limited to a particular type. The display panel 1141 is a rigid type panel, or a flexible type panel, which is rollable or foldable. The display module 1140 may further include a support, a bracket, or a heat dissipater, which supports the display panel 1141.

The scan driver 1142 may be mounted on the display panel 1141 as a driving chip. The scan driver 1142 may be integrated on the display panel 1141. For example, the scan driver 1142 may include an amorphous silicon TFT gate driver circuit, a low temperature polycrystalline silicon (LTPS), a TFT gate driver circuit, or an oxide semiconductor TFT gate driver circuit (OSG), which is internalized in the display panel 1141. The scan driver 1142 may receive a control signal from the controller 1112-1, and output scan signals to the display panel 1141 in response to the control signal.

The display panel 1141 may further include an emission driver. The emission driver may output an emission control signal to the display panel 1141 in response to a control signal received from the controller 1112-1. The emission driver may be formed separately from the scan driver 1142, or may be integrated into the scan driver 1142.

The data driver 1143 may receive a control signal from the controller 1112-1, convert image data into an analog voltage (e.g., a data voltage) in response to the control signal, and output data voltages to the display panel 1141.

The data driver 1143 may be integrated into another component (e.g., the controller 1112-1). The functions of the interface conversion circuit and the timing control circuit of the controller 1112-1 may be integrated into the data driver 1143.

The display module 1140 may further include an emission driver, a voltage generation circuit, and the like. The voltage generation circuit may output various voltages needed to drive the display panel 1141.

The power module 1150 may supply power to the components of the electronic device 1000. The power module 1150 may include a battery to store power voltage. The battery may include a primary cell, which cannot be recharged, and a secondary cell or a fuel cell, which are rechargeable. The power module 1150 may include a power management integrated circuit (PMIC). The PMIC may supply optimized power to each of the foregoing modules and modules to be described below. The power module 1150 may include a wireless power transceiver that is electrically connected with the battery. The wireless power transceiver may include multiple coiled antenna radiators.

The electronic device 1000 may further include an embedded module 1160 and an external mounted module 1170. The embedded module 1160 may include a sensor module 1161, an antenna module 1162, and a sound output module 1163. The external mounted module 1170 may include a camera module 1171, a light module 1172, and a communication module 1173.

The sensor module 1161 may sense an input from the body of the user or an input from a pen of the first input module 1131, and generate an electric signal or a data value corresponding to the input. The sensor module 1161 may include at least one or more among a fingerprint sensor 1161-1, an input sensor 1161-2, and a digitizer 1161-3.

The fingerprint sensor 1161-1 may generate a data value corresponding to the fingerprint of the user. The fingerprint sensor 1161-1 may include any one of an optical fingerprint sensor and a capacitive fingerprint sensor.

The input sensor 1161-2 may generate a data value corresponding to coordinate information of the input from the body of the user or the input from the pen. The input sensor 1161-2 may generate a data value corresponding to the amount of change in capacitance by the input. The input sensor 1161-2 may sense an input from a passive pen, or transmit or receive data to or from an active pen.

The input sensor 1161-2 may measure a biometric signal pertaining to biometric information such as a blood pressure, body fluid, or body fat. For example, in the case where the user brings a part of his/her body into contact with the sensor layer or the sensing panel and remains stationary for a certain time, the input sensor 1161-2 may sense a biometric signal, based on a change in electric field by the part of his/her body, and output information desired by the user to the display module 1140.

The digitizer 1161-3 may generate a data value corresponding to coordinate information of an input from a pen. The digitizer 1161-3 may generate data values corresponding to electromagnetic variations caused by the input. The digitizer 1161-3 may sense an input from a passive pen, or transmit or receive data to or from an active pen.

At least one of the fingerprint sensor 1161-1, the input sensor 1161-2, and the digitizer 1161-3 may be implemented as a sensor layer formed on the display panel 1141 through a successive process. The fingerprint sensor 1161-1, the input sensor 1161-2, and the digitizer 1161-3 may be disposed over the display panel 1141. Any one of the fingerprint sensor 1161-1, the input sensor 1161-2, and the digitizer 1161-3, for example, the digitizer 1161-3, may be disposed under the display panel 1141.

At least two or more of the fingerprint sensor 1161-1, the input sensor 1161-2, and the digitizer 1161-3 may be formed to be integrated into a single sensing panel through the same process. In the case where at least two or more among the fingerprint sensor 1161-1, the input sensor 1161-2, and the digitizer 1161-3 are integrated into a single sensing panel, the sensing panel may be disposed between the display panel 1141 and a window disposed over the display panel 1141. The sensing panel may be disposed on the window, and the position of the sensing panel is not particularly limited.

At least one of the fingerprint sensor 1161-1, the input sensor 1161-2, and the digitizer 1161-3 may be embedded in the display panel 1141. In other words, during a process of forming components (e.g., a light emitting element, a transistor, and the like) included in the display panel 1141, at least one among the fingerprint sensor 1161-1, the input sensor 1161-2, and the digitizer 1161-3 may be formed simultaneously with the components.

The sensor module 1161 may generate an electrical signal or data value corresponding to internal conditions or external conditions of the electronic device 1000. The sensor module 1161 may further include, for example, a gesture sensor, a gyroscope sensor, an atmospheric sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 1162 may include one or more antennas to transmit or receive a signal or power to or from an external device. The communication module 1173 may transmit a signal to an external electronic device or receive a signal from the external electronic device through an antenna suitable for a communication scheme. An antenna pattern of the antenna module 1162 may be integrated to a component of the display module 1140 (e.g., the display panel 1141 of the display module 1140) or the input sensor 1161-2.

The sound output module 1163 may be a device for outputting a sound signal to a device provided outside the electronic device 1000, and, for example, may include a speaker, which is used for typical purposes such as reproducing multimedia or record data, and a receiver, which is used only for phone reception. The receiver may be integrally or separately formed with a speaker. A sound output pattern of the sound output module 1163 may be integrated into the display module 1140.

The camera module 1171 may capture a static image or a video. The camera module 1171 may include one or more lenses, an image sensor, or an image signal processor. The camera module 1171 may further include an infrared camera capable of sensing the presence of the user, the position of the user, a line of sight of the user, etc.

The light module 1172 may provide light. The light module 1172 may include a light emitting diode or a xenon lamp. The light module 1172 may be operated interlocking with the camera module 1171 or operated independently therefrom.

The communication module 1173 may form a wired or wireless communication channel between the electronic device 1000 and the external electronic device 2000, and support execution of communication through the formed communication channel. The communication module 1173 may include either or both a wireless communication module such as a cellular communication module, a short-range wireless communication module, or a global navigation satellite system (GNSS) communication module, and a wired communication module such as a local area network (LAN) communication module, or a power line communication module. The communication module 1173 may communicate with the external electronic device 2000 through a short-range communication network such as Bluetooth, WiFi Direct or infrared data association (IrDA), or a long-range communication network such as a cellular network, an internet, or a computer network (e.g., LAN or WAN). The various types of communication modules 1173 described above may be implemented as a single chip or may be implemented as respective separate chips.

The input module 1130, the sensor module 1161, the camera module 1171, and the like, interlocking with the processor 1110, may be used to control the operation of the display module 1140.

The processor 1110 may output a command or data to the display module 1140, the sound output module 1163, the camera module 1171, or the light module 1172, based on input data received from the input module 1130. For example, the processor 1110 may generate image data in response to input data applied through a mouse, an active pen, or the like and output the image data to the display module 1140, or may generate command data in response to input data and output the command data to the camera module 1171 or the light module 1172. In the case where input data is not received from the input module 1130 for a certain time, the processor 1110 may convert the operation mode of the electronic device 1000 into a low-power mode or a sleep mode so that power consumption of the electronic device 1000 can be reduced.

The processor 1110 may output a command or data to the display module 1140, the sound output module 1163, the camera module 1171, or the light module 1172, based on sensing data received from the sensor module 1161. For example, the processor 1110 may compare authentication data applied from the fingerprint sensor 1161-1 with the authentication data stored in the memory 1120, and may execute an application depending on a result of the comparison. The processor 1110 may execute a command based on sensing data sensed by the input sensor 1161-2 or the digitizer 1161-3, or output corresponding image data to the display module 1140. In the case where the sensor module 1161 includes a temperature sensor, the processor 1110 may receive temperature data for a measured temperature from the sensor module 1161, and further execute a luminance correction operation for the image data based on the temperature data.

The processor 1110 may receive measurement data for the presence of the user, the position of the user, a line of sight of the user, or the like from the camera module 1171. The processor 1110 may further execute a luminance correction operation for the image data based on the measurement data. For example, the processor 1110 that has determined whether the user is present through an input from the camera module 1171 may output, to the display module 1140, image data the luminance of which is corrected by the data conversion circuit 1112-2 or the gamma correction circuit 1112-3.

Some components among the foregoing components may be electrically connected to each other by a communication scheme, e.g., a bus, general purpose input/output (GPIO), a serial peripheral interface (SPI), a mobile industry processor interface (MIPI), or a ultra path interconnect (UPI) link, which can be used between peripheral devices, and may thus exchange a signal (e.g., a command or data) therebetween. The processor 1110 may communicate with the display module 1140 through a predefined interface. For example, any one of the foregoing communication schemes may be used, and the interface is not limited to the foregoing communication schemes.

The electronic device 1000 in accordance with various embodiments disclosed in the present specification may be used to form various types of devices. The electronic device 1000 may include, for example, at least one of a potable telecommunication device (e.g., a smartphone), a computer, a portable multimedia device, a portable medical device, a camera, wearable device, or a home appliance. The electronic device 1000 in accordance with an embodiment of the disclosure is not limited to the foregoing devices.

In the display device in accordance with embodiments of the present disclosure, data units corresponding to a low-resolution area among data units of input image data may be rendered and provided, whereby a luminance difference caused by the low-resolution area can be compensated for. In accordance with embodiments of the disclosure, the display device may be improved in display quality by maintaining substantially equal luminance even in the low-resolution area.

Various embodiments of the disclosure may provide a display device with improved display quality.

The effects of the disclosure are not limited by the foregoing, and other various effects are anticipated herein.

Although certain embodiments and implementations have been described herein, other embodiments and modifications will be apparent from the foregoing description. Accordingly, the concepts of the disclosure are not limited to the foregoing embodiments, but rather to the broader scope of the presented claims and various obvious modifications and equivalent arrangements.

What is claimed is:

1. A display device, comprising:
a display panel including first pixels disposed in a first display area and including first light emitting elements having a first resolution, and second pixels disposed in a second display area around the first display area and including second light emitting elements having a second resolution lower the first resolution; and
a controller that receives input image data including first data units corresponding to the first light emitting elements and second data units corresponding to the second light emitting elements,
wherein the second data units have the first resolution,
the controller generates third data units having the second resolution by rendering the second data units, and
the second light emitting elements are driven based on the third data units.

2. The display device according to claim 1, wherein
the controller generates a first rendered data unit by mixing data units corresponding to a first color among the second data units, and to generate a second rendered data unit by mixing data units corresponding to a second color among the second data units, and
the first and the second rendered data units are included in the third data units.

3. The display device according to claim 2, wherein the controller generates the first rendered data unit by calculating an average of the data units corresponding to the first color among the second data units, and generates the second rendered data unit by calculating an average of the data units corresponding to the second color among the second data units.

4. The display device according to claim 2, wherein light emitting elements corresponding to the first and the second colors among the second light emitting elements are driven based on the first and the second rendered data units.

5. The display device according to claim 1, wherein a light emitting element that emits light of a first color among the second light emitting elements has a size greater than a size of a light emitting element that emits light of the first color among the first light emitting elements.

6. The display device according to claim 1, wherein a number of the second light emitting elements is less than a number of the first light emitting elements.

7. The display device according to claim 1, wherein the second display area is disposed adjacent to at least one of edge areas of the display panel that are positioned around the first display area.

8. The display device according to claim 7, wherein
the edge areas include side edge areas and corner areas connecting the side edge areas to each other,
the side edge areas include:
first and second side edge areas extending in a first direction; and
third and fourth side edge areas extending in a second direction intersecting with the first direction, and formed longer than the first and the second side edge areas,
the corner areas include:
a first corner area connecting the first side edge area and the third side edge area;
a second corner area connecting the third side edge area and the second side edge area;
a third corner area connecting the second side edge area and the fourth side edge area; and
a fourth corner area connecting the fourth side edge area and the first side edge area, and
the second display area is disposed adjacent to at least one of the first to the fourth corner areas.

9. A display device, comprising:
a display panel including first pixels disposed in a first display area and including first light emitting elements, and a second pixel disposed in a second display area adjacent to the first display area and including second light emitting elements; and
a controller that receives input image data including first data units corresponding to the first light emitting elements and second data units corresponding to the second light emitting elements,
wherein the second data units have a first resolution corresponding to the first light emitting elements,
light emitting elements corresponding to an identical color among the second light emitting elements are electrically connected to each other,
the controller generates third data units having a second resolution lower than the first resolution by rendering the second data units, and
the second light emitting elements are driven based on the third data units.

10. The display device according to claim 9, wherein
the second light emitting elements include:
2-1-th light emitting elements that emit light of a first color and electrically connected to each other; and
2-2-th light emitting elements that emit light of a second color and electrically connected to each other,
the controller generates a first rendered data unit by mixing data units corresponding to the first color among the second data units, and generates a second rendered data unit by mixing data units corresponding to the second color among the second data units, and
the first and the second rendered data units are included in the third data units.

11. The display device according to claim 10, wherein the controller generates the first rendered data unit by calculating an average of the data units corresponding to the first color among the second data units, and generates the second rendered data unit by calculating an average of the data units corresponding to the second color among the second data units.

12. The display device according to claim 10, wherein
the 2-1-th light emitting elements are driven together based on the first rendered data unit, and
the 2-2-th light emitting elements are driven together based on the second rendered data unit.

13. The display device according to claim 10, wherein
the second light emitting elements further include:
2-3-th light emitting elements that emit light of a third color and electrically connected to each other; and
2-4-th light emitting elements that emit light of the third color and electrically connected to each other,
the controller generates a third rendered data unit by mixing some of data units corresponding to the third color among the second data units, and generates a fourth rendered data unit by mixing some other of the data units corresponding to the third color among the second data units, and
the third data units further include the third and the fourth rendered data units.

14. The display device according to claim 13, wherein the controller generates the third rendered data unit by calculating an average of some of the data units corresponding to the third color among the second data units, and generates the fourth rendered data unit by calculating an average of some other of the data units corresponding to the third color among the second data units.

15. The display device according to claim 13, wherein
the 2-3-th light emitting elements are driven together based on the third rendered data unit, and
the 2-4-th light emitting elements are driven together based on the fourth rendered data unit.

16. The display device according to claim 9, wherein
the display panel further includes first sub-pixel circuits respectively electrically connected to the first light emitting elements, and second sub-pixel circuits electrically connected to the second light emitting elements, and
the light emitting elements corresponding to the identical color among the second light emitting elements are electrically connected together to any one of the second sub-pixel circuits.

17. The display device according to claim 9, wherein a number of the second light emitting elements are substantially equal to a number of the first light emitting elements.
